(19) United States
(12) Patent Application Publication
(10) Pub. No.: US 2015/0163341 A1
(43) Pub. Date: Jun. 11, 2015

(54) VIRTUAL PERSONAL OPERATOR

(71) Applicants: John Skovron, Bellevue, WA (US); Krishnan Ananthanarayanan, Redmond, WA (US); Jeffrey Cheng-Yao Fong, Seattle, WA (US); Eric Jonathan Hull, Seattle, WA (US); Reid Kuhn, Kirkland, WA (US); David E. Lemson, Redmond, WA (US); Ganapathy Raman, Redmond, WA (US); Mahendra Sekaran, Sammamish, WA (US); Lavanya Vasudevan, Sammamish, WA (US); Aaron Woo, Bellevue, WA (US); Kerry D. Woolsey, Duvall, WA (US); Aaron Woodman, Seattle, WA (US)

(72) Inventors: John Skovron, Bellevue, WA (US); Krishnan Ananthanarayanan, Redmond, WA (US); Jeffrey Cheng-Yao Fong, Seattle, WA (US); Eric Jonathan Hull, Seattle, WA (US); Reid Kuhn, Kirkland, WA (US); David E. Lemson, Redmond, WA (US); Ganapathy Raman, Redmond, WA (US); Mahendra Sekaran, Sammamish, WA (US); Lavanya Vasudevan, Sammamish, WA (US); Aaron Woo, Bellevue, WA (US); Kerry D. Woolsey, Duvall, WA (US); Aaron Woodman, Seattle, WA (US)

(21) Appl. No.: 14/102,260

(22) Filed: Dec. 10, 2013

(51) Int. Cl. H04M 1/725; H04W 4/12; H04W 68/00

(52) U.S. Cl. CPC H04M 1/72569; H04W 68/005; H04W 4/12

(57) ABSTRACT

Various technologies for managing mobile device communications can be offered to implement a virtual personal operator. Incoming calls and texts can be managed intelligently based on a rich network-stored context, allowing the network to make decisions and interact with callers. Because context is stored by the network, the virtual personal operator can function without contacting the called mobile phone, and can even provide helpful information to callers if the mobile phone is offline. Rich do-not-disturb functionality can be provided, and privileged callers can be given additional information or functionality based on their privileged status. Numerous other features that assist with communications management can be supported.

### BACKGROUND

Mobile phones are now considered to be indispensable communications devices. Due to advances in technology, the number and types of communications that can be handled by a single device is unprecedented. However, users can be overwhelmed by the volume of traffic directed at their device. For example, a user may find it difficult to manage the numerous calls, messages, and notifications that arise on a daily or even hourly basis. Due to the rich connectivity provided by mobile phones, a user can be constantly interrupted and is eventually faced with deciding whether to ignore certain communications. Due to other activities competing for the user's attention, decisions regarding whether to accept a call can be made in haste or not at all.

Many phones have do-not-disturb functionality, but such functionality typically blocks all calls. So a user can invoke do-not-disturb functionality only to later learn that an important call was missed.

Other problems can arise when a device loses connectivity to the network. Missed incoming communications while offline may be important, but they can end up lost in voicemail or not received at all.

Because users can face frustration and information overload when interacting with their mobile devices, there remains room for improvement, especially in the area of managing incoming communications.

### SUMMARY

The Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

A virtual personal operator can provide a rich set of technologies to assist a user by intelligently managing various incoming communications based on a network-stored context, network-stored information about callers, network-stored assistant preferences, or combinations thereof. A number of recurring scenarios can be recognized and handled by the virtual personal operator to assist the user, whether the user is offline, busy, in a meeting, driving, or otherwise unavailable.

Because functionality can be provided by the network, the technologies can be implemented without contacting the called device and even if the called device is offline.

In one embodiment, a method is implemented at least in part by a computing system, and the method includes, responsive to detection of an incoming communication directed from a calling device to a called device, based on a network-stored context derived from the called device, network-stored assistant preferences derived from the called device, or network-stored information about the calling device, choosing an action for the incoming communication; and performing the chosen action for the incoming communication.

In another embodiment, a system comprises a processor; memory coupled to the processor; and a personal communications assistant engine coupled to a mobile device context for a mobile device stored outside of the mobile device, calendar information for the mobile device stored outside of the mobile device, and contact information for the mobile device stored outside of the mobile device; wherein the personal communications assistant engine is configured to: determine that the mobile device is in a do-not-disturb status; assemble a personalized greeting to a calling device indicating the do-not-disturb status; determine that the calling device has a privileged status; and include additional information in the personalized greeting based on the privileged status of the calling device.

In another embodiment, one or more computer-readable storage media comprise computer-executable instructions causing a computer to perform a method comprising: responsive to an indication of an incoming call from a calling device to a called device, based on a stored context derived from the called device, the context indicating that the called device is in a do-not-disturb status, intercepting the incoming call; detecting that the incoming call is coming from a device indicated as having a privileged status in a contacts list stored remotely from the called device; generating a personalized greeting based on the stored context derived from the called device, wherein the generating comprises, responsive to detecting that the incoming call is coming from a device indicated as having a privileged status, including an option to break through the do-not-disturb status, and the generating comprises including a name associated with the calling device in the contacts list stored remotely from the called device; sending the personalized greeting to the calling device, wherein the personalized greeting comprises the option to break through the do-not-disturb status and the name associated with the calling device in the contacts list stored remotely from the called device; receiving an indication from the calling device that the option to break through the do-not-disturb status has been activated; and responsive to receiving the indication, forwarding the incoming call to the called device, thereby breaking through the do-not-disturb status.

As described herein, a variety of other features and advantages can be incorporated into the technologies as desired.

### BRIEF DESCRIPTION OF THE DRAWINGS

FIG. 1 is a block diagram of an exemplary system implementing a communications service supporting virtual personal operator technologies.

FIG. 2 is a flowchart of an exemplary method of implementing a communications service supporting virtual personal operator technologies.

FIG. 3 is a block diagram showing how both serviced and unserviced devices can benefit from the described communications service.

FIG. 4 is a block diagram showing an exemplary communications service implementing network-stored context, network-stored caller information, and network-stored assistant preferences accessible by a personal communications assistant engine.

FIG. 5 is a flowchart of an exemplary method of implementing additional information for privileged calling devices.

FIG. 6 is a data flow diagram showing formation of a personalized greeting for an in-meeting condition where the caller is privileged.

FIG. 7 is messaging diagram showing an implementation of breaking through do-not-disturb status.

FIG. 8 is a data flow diagram showing formation of a personalized greeting for an in-meeting condition where the caller is not privileged.

FIG. 9 is a data flow diagram showing formation of a personalized greeting for a depleted battery condition where the caller is privileged.

FIG. 10 is a data flow diagram showing formation of a personalized greeting for a depleted battery condition where the caller is not privileged.

FIG. 11 is a flowchart of an exemplary method of providing a special notification for missed calls in a noisy environment.

FIG. 12 is a wire frame of an exemplary do-not-disturb settings user interface for use with the virtual personal operator technologies described herein.

FIG. 13 is a wire frame of an exemplary privilege granting user interface for use with the virtual personal operator technologies described herein.

FIG. 14 is a wire frame of an exemplary user interface for implementing privilege status via a contact card.

FIG. 15 is a wire frame of an exemplary personalized greeting settings user interface for use with the virtual personal operator technologies described herein.

FIG. 16 is a wire frame of an exemplary user interface presenting notifications as part of a call history.

FIG. 17 is a wire frame of an exemplary text message user interface implementing do-not-disturb breakthrough.

FIG. 18 is a block diagram of an exemplary table showing available features according to privilege category.

FIG. 19 is a diagram of an exemplary computing system in which described embodiments can be implemented.

FIG. 20 is an exemplary mobile device that can be used for the technologies described herein.

FIG. 21 is an exemplary cloud-support environment that can be used in conjunction with the technologies described herein.

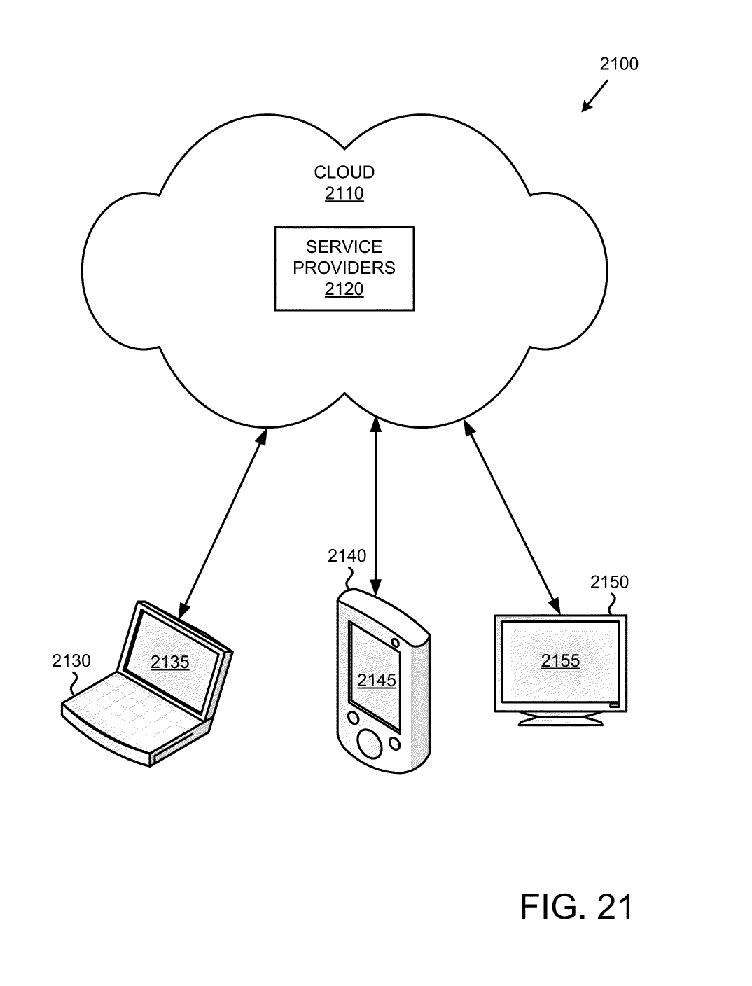

### DETAILED DESCRIPTION

### Example 1

### Exemplary Overview

The technologies described herein can be used for a variety of communications management scenarios, and adoption of the technologies can provide improved techniques for managing communications. The user interfaces and flow between them can help users personalize the mobile experience for themselves and the persons with which they interface. An overall superior user experience with more personalization and more efficient communication can result.

Personalized greetings can be presented to callers via a network-stored context and other network-stored information, such as assistant preferences or information about the calling device. Such information can be used to make decisions about how to handle incoming calls and determine which post-greeting follow up functionality is available.

After presentation of the personalized greeting, the post-greeting follow up functionality can be activated by the calling device as described herein. Additional options can be made available to contacts that have been awarded privileged status, and multiple privilege levels can be supported. Access to different features or content can be independently granted and controlled based on different respective privilege levels that can be configured according to user preferences.

The technologies can be helpful for those wishing to personalize their mobile experience and/or those wishing to avoid communications overload. Beneficiaries can include those using devices that are serviced by the technologies described herein and those who communicate with such users.

The technologies can be used to implement voice-driven, cloud-based communications management.

Various other features can be implemented and combined as described herein.

### Example 2

### Exemplary System Implementing Virtual Personal Operator

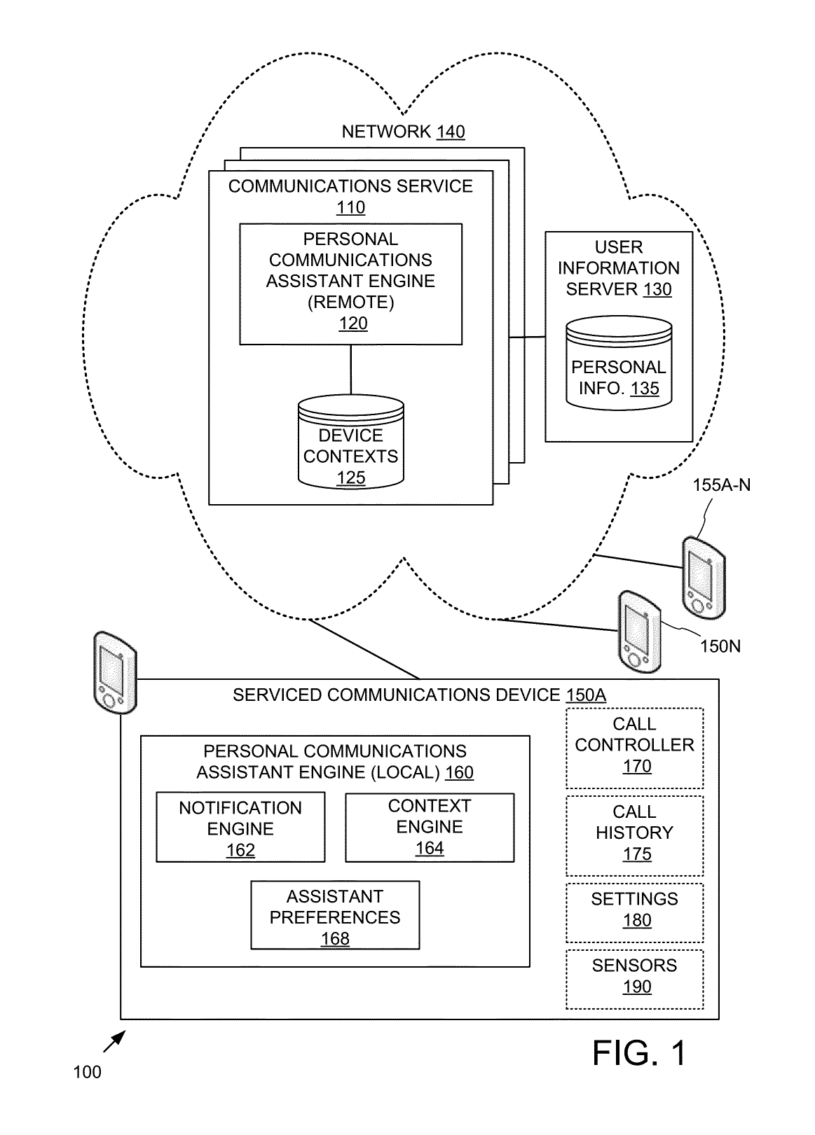

FIG. 1 is a block diagram of an exemplary system 100 implementing virtual personal operator technologies as described herein.

For purposes of context, FIG. 1 shows that the communications service 110 can be part of a network 140 that provides connectivity and interacts with both serviced communications devices 150A-N and unserviced communications devices 155A-N.

In the example, a user information server 130 provides personal information 135 to the communications service 110 so the personal communications assistant engine 120 (e.g., remote from the device 150A) can make intelligent decisions about how to handle incoming communications directed to the called (e.g., serviced) communications device 150A via consultation of a device context for the called device (e.g., stored in the device contexts 125) and personal information 135 associated with the service communications device 150A (e.g., stored by the user information server 130).

Although a single network 140 is shown, in practice, a plurality of networks (e.g., by the same or different carriers) can be implemented. Similarly, the personal information 135 and the device contexts 125 can be stored in any arbitrary location outside of the called communications device 150A. For example, a storage abstraction such as cloud storage can be implemented, rendering the details of where the information is actually stored irrelevant to the technologies. Although some elements are depicted as discrete items, in practice the boundaries between the items can be varied as desired for implementation. For example, although information is shown in examples as stored together, in practice, data can be spread and/or duplicated throughout the system. Functionality can be integrated throughout the network 140 and can be accomplished via an operating system, applications, or combinations thereof implemented in hardware, software, or both.

In the example, a serviced communications device 150A comprises a personal communications assistant engine 160 (e.g., local to the device 150A) that can comprise a local notification engine 162, a context engine 164, and assistant preferences 168. A call controller 170, call history 175, settings 180, and sensors 190 can also be included.

In practice, the systems shown herein, such as system 100 can be more complicated, with additional functionality, more devices, more services, and the like.

The system 100 and any of the other systems described herein can be implemented in conjunction with any of the hardware components described herein, such as the computing systems described below (e.g., processing units, memory, and the like). In any of the examples herein, the inputs, outputs, and engines can be stored in one or more computer-readable storage media or computer-readable storage devices. The technologies described herein can be generic to the specifics of operating systems or hardware and can be applied in any variety of environments to take advantage of the described features.

### Example 3

### Exemplary Method Implementing Virtual Personal Operator

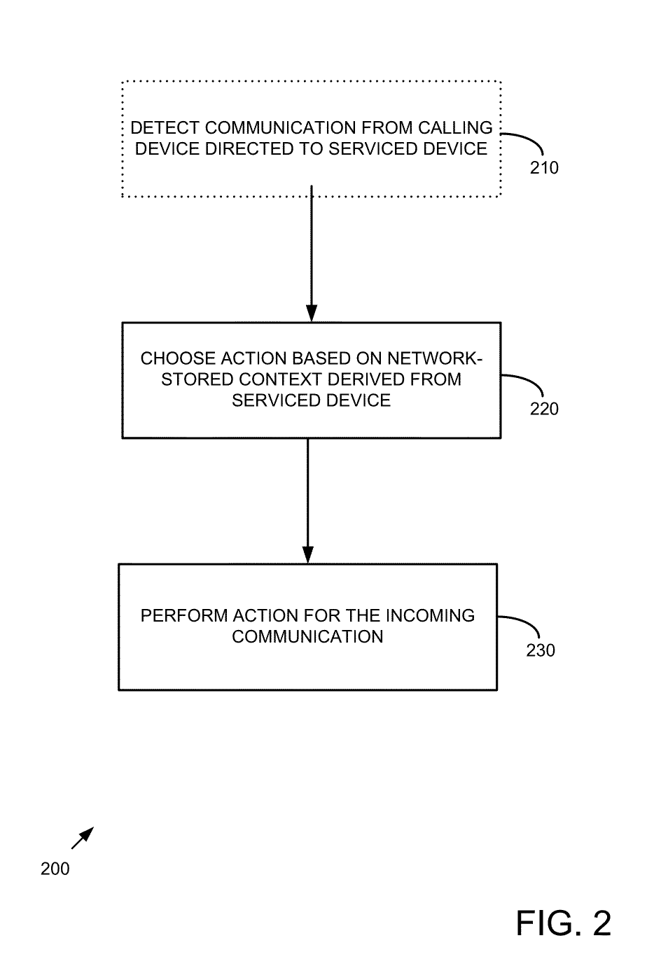

FIG. 2 is a flowchart of an exemplary method 200 of implementing a virtual personal operator and can be implemented, for example, in the system shown in FIG. 1 (e.g., by the communications service). As with the other methods described herein, the order of the acts can be immaterial (e.g., they can be reversed or the like).

At 210, a communication directed to a called (e.g., serviced) device is detected. In practice, the incoming communication can be an incoming phone call or incoming text message. The communication can be intercepted before ringing or sending to the called device.

At 220, an action is chosen for the incoming communication based on the network-stored context derived from the called device, network-stored assistant preferences derived from the called device, network-stored information about the calling device, or combinations thereof. Various examples of supported actions are described herein, and include providing a personalized greeting to the calling device, sending (e.g., immediately or queuing for sending) a notification message to the called device, and forwarding the incoming communication to the called device. For example, the choosing can switch between providing a greeting and forwarding the communication to the called device based on the context (e.g., on whether the context indicates that the called device is offline or in a do-not-disturb status). So, a personalized greeting can be provided if the context indicates the device is offline or in do-not-disturb status instead of forwarding the call to the called device as would ordinarily be done.

In cases where a user identity associated with the called device is detected as present at another device, the action can be forwarding the communication to the other device instead of the called device as described herein.

At 230, the chosen action is performed for the incoming communication. As described herein, the method 200 can be performed without contacting the called device. For example, the called device can be offline, and a greeting can be provided to the calling device or a notification message can be queued for sending to the called device (e.g., when the device regains connectivity).

In practice, the choosing 220 can switch between providing a greeting or forwarding the incoming communication (e.g., depending on context, assistant preferences, information about the calling device, or combinations thereof). A notification message can result as a byproduct (e.g., if the call is missed or the like). However, in some cases, multiple actions can be taken (e.g., a greeting is provided, but then the communication is subsequently forwarded). Avoiding interruptions can be accomplished without deferring delivery. For example, the communication can be forwarded as usual, but the notification can be silenced (e.g., a text message is delivered normally, but the notification sound is suppressed).

Input from the calling device can be received to influence operation of the virtual personal operator technologies as described herein. For example, post-greeting follow up functionality can be performed responsive to activation of such functionality by the calling device.

The method 200 and any of the other methods described herein can be performed by computer-executable instructions (e.g., causing a computing system to perform the method) stored in one or more computer-readable media (e.g., storage or other tangible media) or stored in one or more computer-readable storage devices.

### Example 4

### Exemplary Virtual Personal Operator

In any of the examples herein, a network can include a communications service implementing virtual personal operator technologies that can serve as a virtual personal operator or assistant. For example, a personal communications assistant engine can function remotely from serviced devices and provide a variety of functionality to both serviced and unserviced devices as described herein.

### Example 5

### Exemplary Personal Information

In any of the examples herein, the network-stored personal information (e.g., personal information 135) can include a wide variety of information such as contact information (e.g., the contacts stored by the serviced (e.g., called) communications device 150A, including privilege status associated with the contacts), calendar information (e.g., the calendar information stored by the serviced communications device 150A), assistant preferences (e.g., assistant preferences stored by the serviced communications device 150A), and other information helpful for providing a personalized experience to calling devices.

Such information can be derived (e.g., fully or partially) from the serviced device 150A as described herein.

### Example 6

### Exemplary Network-Stored Information about Calling Device

In any of the examples herein, the network can store information about a calling device. For example, the stored contacts information can be consulted to look up information about a calling device (e.g., via the calling device's phone number or other indication of caller identity). Calls can originate from applications executing on the calling device. In such a case, the information about the calling device can take the form of a user identity or other indication of caller identity and be supplied by the calling application.

Such information can be derived from the called device, whether directly or indirectly, or a user identity associated with the called device. For example, the called device can contain a contacts entry that includes the calling device's phone number, a name, privilege status, or the like. Although such network-stored information is typically also stored at the called device, it may have originated from the called device or come from other sources. A user identity associated with the called device can be used to enter information independently of the called device. For example, user preferences, contact information, information for other communications services, and the like can be stored in the cloud and managed via the user identity by any device having access to the cloud.

### Example 7

### Exemplary Network-Stored Assistant Preferences

In any of the examples herein, the network can store assistant preferences for use by the personal communications assistant engine. Such assistant preferences can indicate whether certain information is to be provided to callers, and the amount of such information. The preferences can also be set so that whether such information and the amount depends on a privilege status of the calling device.

Such preferences can be derived from the called device. For example, a user can be presented with a user interface by which the assistant preferences are set. They can be presented as greeting preferences or the like. A range of options including presenting no extra information to anyone can be set.

### Example 8

### Exemplary Device Context

In any of the examples herein, a device context (e.g., stored in the contexts 125) can be stored and maintained by the network and indicate any of a variety of contextual data for the serviced (e.g., called) communications device. For example, context variables indicating a variety of sensor conditions, situations, and device settings can be indicated by the network-stored context. Exemplary context variables are shown in the table below:

TABLE 1
Exemplary Device Context Variables

| Category | Context Variable | Description |
|---|---|---|
| Sensor | Positioning sensors | Indicates a physical |
| | (e.g., GPS) | location (e.g., latitude, |
| | | longitude, and altitude); can |
| | | be translated into a friendly |
| | | name (e.g., “home,” “work,” |
| | | “gym,” etc.). |
| Sensor | Proximity | Whether the device |
| | | is near the user; whether |
| | | the device is being held up |
| | | for speaking into the |
| | | microphone; whether |
| | | device is in a pocket or |
| | | purse |
| Sensor | Mic | Whether any sound |
| | | is present; the level of such |
| | | sound; can be translated |
| | | into a condition (e.g., |
| | | “quiet,” “conversational,” |
| | | “loud”) |
| Sensor | Acceleration | Indicates |
| | | acceleration; can be |
| | | translated into whether the |
| | | device is being moved |
| Sensor | Battery | Indicates battery |
| | | level or condition |
| Sensor | Signal Level | Indicates wireless |
| | | phone signal level or |
| | | condition |
| Situation | In Meeting | Can be determined |
| | | with reference to calendar |
| | | associated with device |
| Situation | Home Wi-Fi | Can be determined |
| | | by detecting presence of |
| | | home Wi-Fi signal; can be |
| | | translated into friendly |
| | | name of “at home” |
| Situation | Day/Time | Can be translated |
| | | into friendly name (e.g., |
| | | “day” “night” “evening” |
| | | “weekend” “working |
| | | hours”) |
| Situation | Bluetooth paired | Can indicate |
| | | whether the device is paired |
| | | with a Bluetooth device |
| Situation | Roaming | Can indicate |
| | | whether the device is |
| | | outside of the normal |
| | | carrier area, international, |
| | | or the like |
| Situation | Power | Whether the device |
| | | is powered on |
| Situation | Charging | Whether the device |
| | | is charging |
| Situation | Recurring calls | Can indicate a |
| | | recurring caller (e.g., has |
| | | called x times in the past y |
| | | minutes), which may |
| | | indicate an urgent situation |
| Situation | Driving | Can be inferred from |
| | | positioning sensor, |
| | | accelerometer, or the like. |
| | | Alternatively or in addition, |
| | | can be a setting. |
| Connectivity | Online | Whether the device |
| | | is online with the network |
| Settings | Do-not-disturb | Can indicate that the |
| | | device is in do-not-disturb |
| | | status and why |
| Settings | Ringer | Can indicate the |
| | | level of the ringer and/or |
| | | whether it is turned off |
| Settings | Airplane | Can indicate |
| | | whether the device has |
| | | been placed in Airplane |
| | | mode |
| Settings | Driving | Can indicate |
| | | whether the device is in |
| | | Driving mode. Alternatively, |
| | | or in addition, can be a |
| | | situation. |

Although particular categories are shown, alternatives can be implemented as desired. Additional or fewer context variables can be incorporated into the technologies.

In practice, the device can communicate some variables to the network to maintain the network-stored context. Others can be inferred or assembled from data originating at the device. Such context is said to be derived from the called device because the called device can supply data on which the context is based. For example, if the device is used to set up a meeting, an in-meeting status can subsequently be derived from the meeting, even if the meeting information is stored by the network in a calendar, and the in-meeting status can be determined without contacting the device. Thus, in the example, the network can indirectly derive do-not-disturb status from the device via the fact that a meeting was set via the device.

Similarly, the fact that a device is online can be derived from the device (e.g., the device indicates that it is online). By inference, the fact that a device is offline can also be so derived.

### Example 9

### Exemplary Network-Stored Information

In any of the examples herein, various information for use by the personal communications assistant engine can be stored by the network. Thus, the information can be accessed by the network without contacting the called device or the calling device. In practice, such information can also be stored by the called device, but is also stored outside of the called device so that it can be accessed as described herein, even if the called device is offline.

Thus, for purposes of being “network-stored,” the called device is not considered part of the network, even though it can benefit from connectivity to the network.

For example, when an incoming communication is processed by the network, the network stored context derived from the called device can be accessed while the called device is offline of (e.g., disconnected from) the network processing the incoming communication.

### Example 10

### Exemplary Privilege Status

In any of the examples herein, a contact can be associated with a privilege status. An incoming communication can then be assigned the privilege status associated with the related contact. For example, the incoming number can be used to determine which contact is calling. Any number of techniques can be used to achieve privilege status. For example, an inner circle of contacts can be assigned a status of “privileged” while those outside the circle are not. Other designations, such as “close contacts,” “best friends,” “family,” “VIP,” or the like can be used.

An indicated level of privilege can control which calling devices receive which information and options as described herein. Multiple privilege levels can be supported. For example, a recent caller or recently called number can be assigned a privilege status higher than an unknown number. Numbers appearing in the contacts list associated with the called device can be assigned a higher privilege than so-called “bare” numbers (e.g., numbers that do not match any entry in the contacts list and are considered to be unidentified). Numbers appearing in a call history can be assigned a higher privilege than unknown bare numbers. Called numbers in the history can be assigned a higher privilege than calling numbers.

Further, access to different features can be granted based on different privilege status. For example, access to one feature may be granted if a first privilege status is indicated, but access to another feature may be granted only if a second, different privilege status is indicated.

The virtual personal operator service can handle incoming communications to and from a user identity and need not be limited to a single device. As a subscriber to the service, the called user identity can have contacts and respective privilege statuses associated with the contacts. An incoming communication to any of the called user identity's devices from any of a given contact's devices can be handled according to the privilege status associated with the given contact in contact information stored by the network for the called user identity of the subscriber. In other words, calling contacts can be awarded privilege status according to the called user's contacts list, which can be stored by the network.

### Example 11

### Exemplary Inclusive System

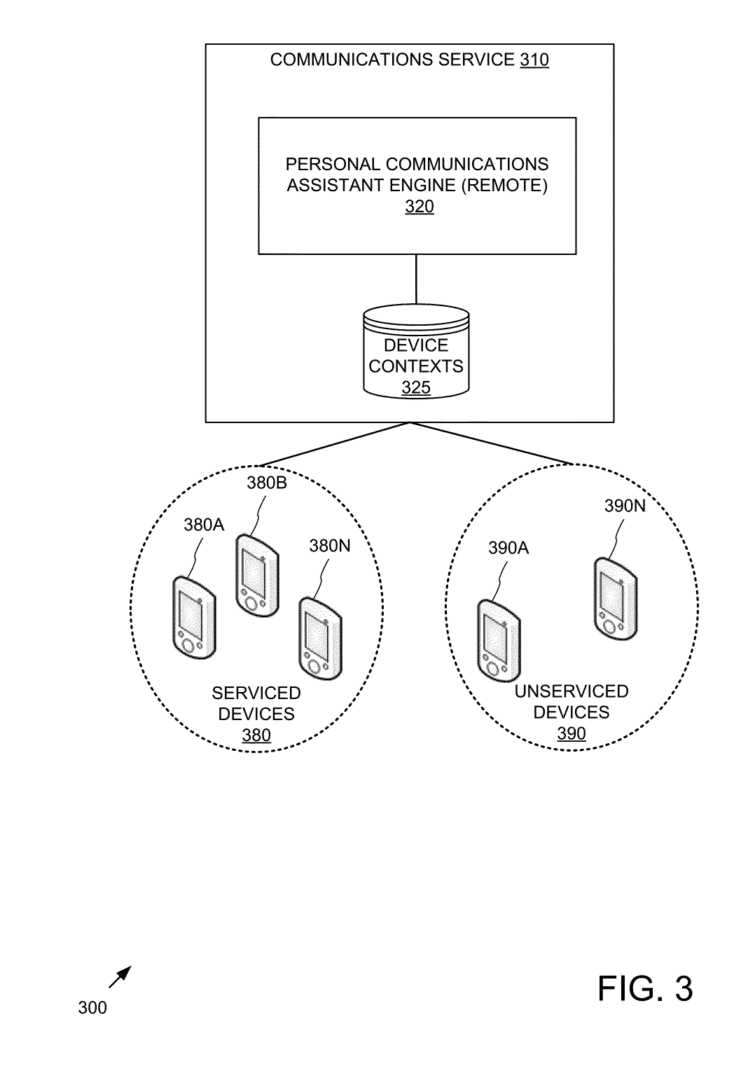

FIG. 3 is a block diagram showing how both serviced 380 and unserviced devices 390 can benefit from the described communications service in an inclusive system 300. In the examples herein, communications are directed to a serviced device 380A-N. The communications service 310 can maintain network-stored device contexts 325 for respective of the serviced devices 380A-N. Although a calling device can be a serviced device 380A-N, the technologies can also work when receiving communications from unserviced devices 390A-N.

For example, personalized greetings can be provided to the unserviced devices 390, unserviced devices 390 can be given options to break through do-not-disturb status, and the like.

### Example 12

### Exemplary Personal Communications Assistant Engine Consulting Network-Stored Information

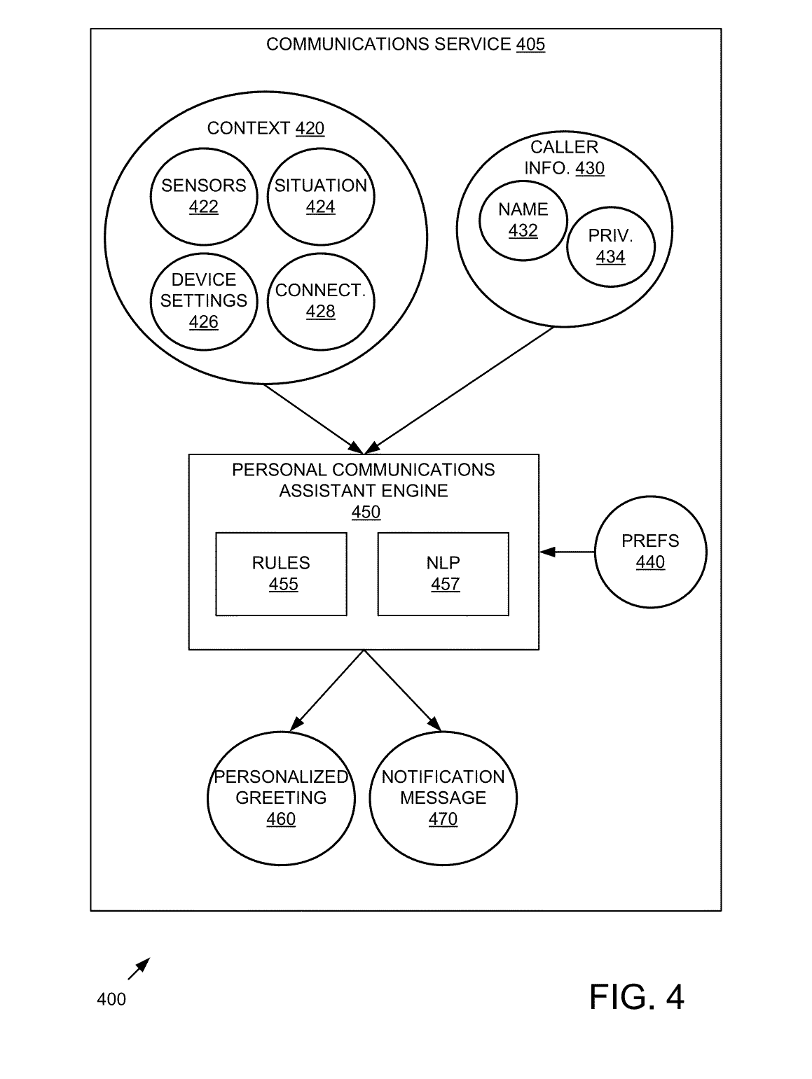

FIG. 4 is a block diagram showing an exemplary communications service 405 implementing network-stored context 420, network-stored caller information 430, and network-stored assistant preferences 440 accessible by a personal communications assistant engine 450.

In the example, a personal communications assistant engine 450 accepts network-stored context 420 and calling device information 430, along with assistant preferences 440, to output a personalized greeting 460, notification message 470, or both.

As described herein, the context 420 can include any of a wide variety of factors, including context 422 relating to sensors at the called device, context 424 relating to a situation at the called device, device settings 426, and connectivity status 428 of the called device.

In any of the examples herein depicting calling device information (e.g., 430, 630, etc.), such information can be derived from a phone number associated with an incoming communication (e.g., by consulting network-stored contact information derived from the called device) and can include a name (e.g., text or audio pronunciation) associated with the calling device, a privilege status associated with the calling device, whether the calling device has recently called, and the like.

The personal communications assistant engine 450 can include rules 455 to decide how to choose actions and natural language processing functionality 457 to determine how to generate outgoing and process incoming natural language (e.g., textual, audio, or both) as described herein.

The personalized greeting 460 can be directed to the calling device and take any of a variety of forms as described herein. As described herein, the notification message 470 can be queued for sending to the called device and can take a variety of forms (e.g., indicating a missed call or the like).

### Example 13

### Exemplary Privileged Callers Processing

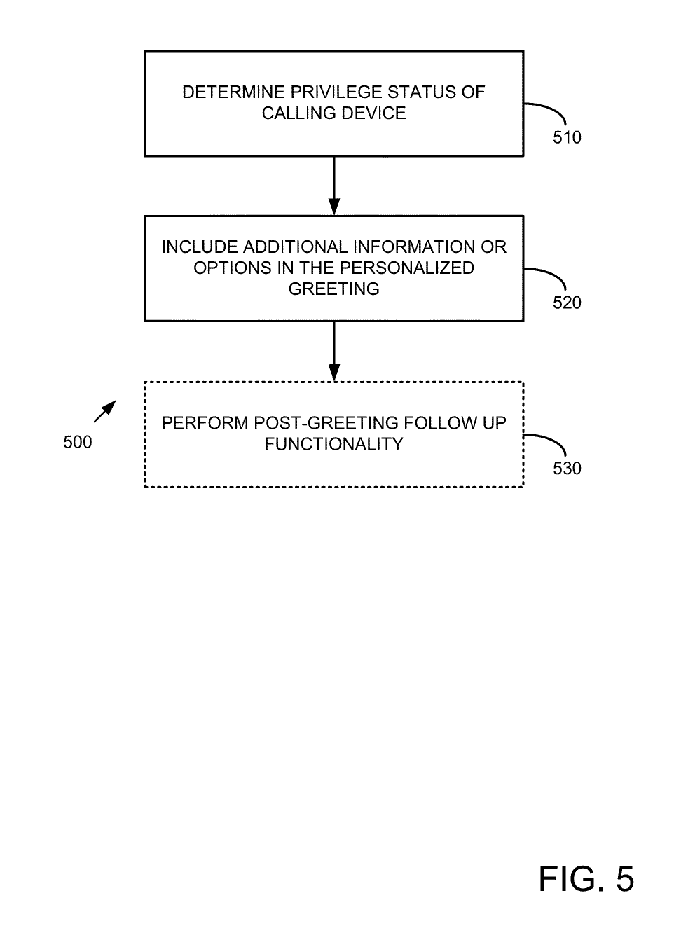

FIG. 5 is a flowchart of an exemplary method 500 of implementing additional information for privileged calling devices and can be implemented in conjunction with the personalized greeting technologies described herein. Although the terminology “calling” devices is used, the technologies can be equally applied to text messages as shown herein.

At 510, the privilege status of a calling device is determined. For example, a phone number associated with a calling device can be used to find a network-stored contact record and privilege status associated therewith.

At 520, responsive to determining that the calling device has privileged status, additional information or an option can be included in the personalized greeting. As described herein, such information can include location information about the called device. Such options can include the option to breakthrough do-not-disturb status. In the alternative, the option need not explicitly be included in the personalized greeting, but it can be included as one of the accepted responses to the greeting.

For example, in do-not-disturb scenarios, based on detecting that the network-stored information indicates that the calling device is a privileged calling device, an option can be included in the personalized greeting for breaking through do-not-disturb status.

The personalized greeting can be assembled as described herein and then output to the calling device.

At 530 optional post-greeting follow up functionality can be performed. For example, in response to the personalized greeting, the calling device can select or articulate (e.g., via voice or text) options to activate them. As described herein, such actions can include breaking through do-not-disturb status, dictating a message as a text, adding a reminder, adding a to-do, or the like.

### Example 14

### Exemplary Do-Not-Disturb Status

In any of the examples herein, a do-not-disturb status can be set manually (e.g., by a user via a setting on the device). However, do-not-disturb status can also be inferred based on a condition or situation detected in the network-stored context, such as an in-meeting condition, a driving condition, an airplane mode, a callee-is-sleeping condition, an at-work condition, or the like.

Based on assistant preferences and privilege status of the calling device, additional information about the status can be provided in the personalized greeting to callers. For example, an indication of the detected condition (e.g., “Allen is driving”) can be included in any of the personalized greetings described herein. Such indication can be provided responsive to verifying that assistant preferences indicate that such situation information is to be provided. Information can be limited to those with privileged status.

Patterns of do-not-disturb can be detected and used to provide the user with an opportunity to automatically set do-not-disturb status for time blocks. For example, if it is detected that the user constantly sets do-not-disturb status at a certain time block (e.g., every Friday at 10 PM), an option to automatically set the status can be presented (e.g., “Would you like to set this time automatically as do-not-disturb?”). If accepted, the status can then be automatically set for the time block in the future.

Content (e.g., emails, text conversations, or the like) on the device can be mined to determine do-not-disturb status or to propose time blocks.

Sleeping status can be inferred based on movement, observed patterns, or settings. Similarly, an at-work condition can be inferred based on meetings, observed patterns, or the like.

### Example 15

### Exemplary Call Forwarding

In any of the examples herein, if a called device is offline and a user identity associated with the called device is detected as present at another device, the call can be forwarded to the other device instead of the called device. Such forwarding can be enabled by a user preference and can be associated with a privilege status (e.g., only forward calls for contacts having a high privilege level). Forwarding can be done to a user address or identifier rather than phone number. In this way, the virtual personal operator can put the caller in touch with the called user on a different device type (e.g., computer or the like).

Forwarding can be done before a personalized greeting is presented or selected as an option after the personalized greeting is presented. The personalized greeting can explicitly present the option (e.g., “Alan is on his computer, would you like to contact him there?”) or the option can simply be implicit. An implicit option can be invoked responsive receiving a command to forward the call from the calling device (e.g., upon receiving “Find Alan,” the forwarding is implemented).

### Example 16

### Exemplary Personalized Greeting Assembly

In any of the examples herein, a personalized greeting can be assembled from any of the network-stored information available to the communications assistant engine. Examples include a name (e.g., spoken) associated with a user of the called device, a name (e.g., spoken) associated with a user of the calling device (e.g., based on the network-stored information about the calling device), any contextual information (e.g., including duration, times, locations, or the like), or other available information.

Natural language processing techniques can be employed so that the personalized greeting is understood and adheres to human language conventions. The content of the personalized greeting can be chosen to indicate the context in natural language. For example, if do-not-disturb status is detected, the words “unavailable,” “busy,” or the like can be used. If the called device is detected to be off line, the words “unavailable,” “offline,” “disconnected,” “not on the network,” or the like can be used. As described herein, additional information can be included such as why (e.g., the causing condition) the callee is unavailable (e.g., “in a meeting.”)

Whether such information is included and the amount of it can be controlled via assistant preferences and depend on whether the calling device has a privileged status.

For example, responsive to determining a privilege status of a calling device in the network-stored information about the calling device (e.g., by relating an incoming number with a contact that has a privilege status), additional information or an option can be included in the personalized greeting. Such information can comprise an indication of an in-meeting condition and an indication of when the in-meeting condition ends; a driving condition; an indication that the battery is not supporting normal communications (e.g., and an indication of a last known location of the called device). Such an option can comprise an option to break through do-not-disturb status.

### Example 17

### Exemplary Personalized Greeting for In-Meeting Condition (Privileged)

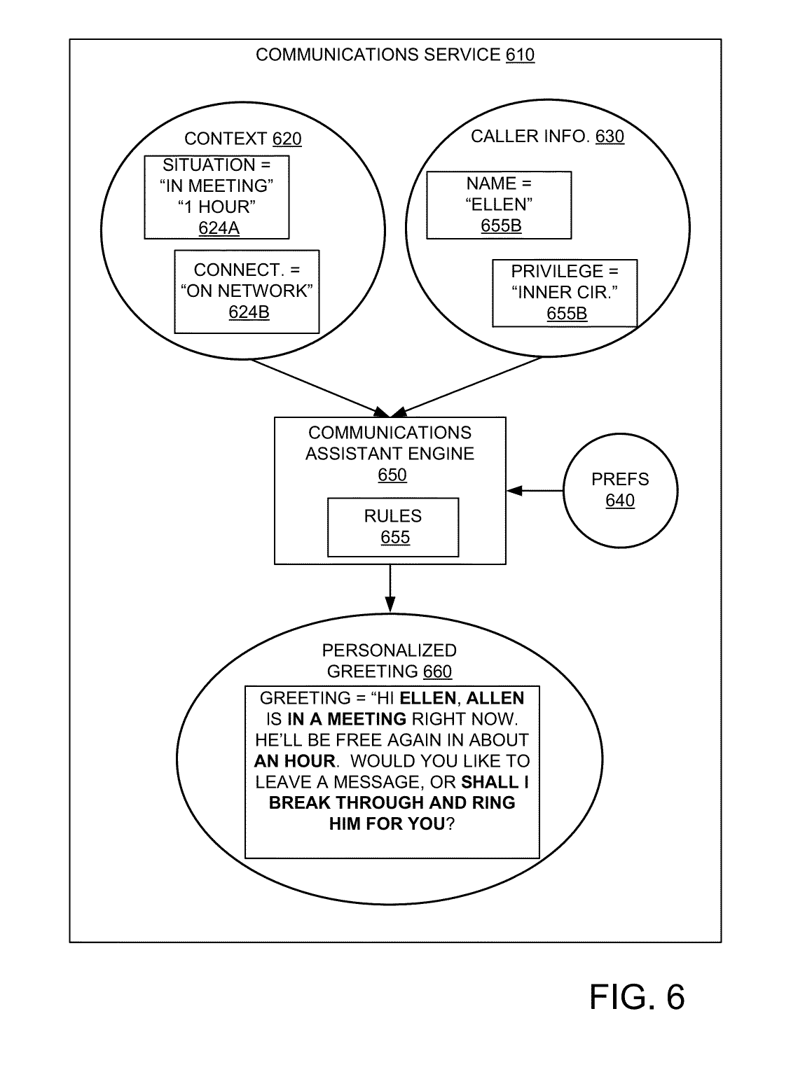

FIG. 6 is a data flow diagram showing formation of a personalized greeting 660 for an in-meeting condition where the caller is privileged as handled by a communications service 610. In the example, the network-stored context 620 indicates a situation 624A (situation=“in meeting” and duration of “1 hour”) and connectivity status (e.g., “on network”). The calling device information 630 indicates the name 655B for the calling device (“Ellen”) and a privilege status 655B indicating privilege (“inner circle”). In any of the examples herein (e.g., shown in FIGS. 6, 8, 9, 10), the communications assistant engine 650 can apply the context 620, caller information 630, assistant preferences 640, or combinations thereof to the rules 655 to generate content of the greeting, choose available options, or both.

In the example, a personalized greeting 660 includes the name associated with the calling device and a name associated with the called device. Based on detection that the calling device is associated with a privileged status, the user's current status (e.g., situation such as “is in a meeting”), including a duration of the status (e.g., “until 3 PM,” “about an hour,” or the like) according to the context (e.g., user's calendar) is included in the personalized greeting 660. Further based on the privileged status, an option to break through do-not-disturb status is included in the personalized greeting 660.

Although the example is shown for an in-meeting status, other do-not-disturb conditions can be similarly supported.

### Example 18

### Exemplary Break Through Messaging Technique

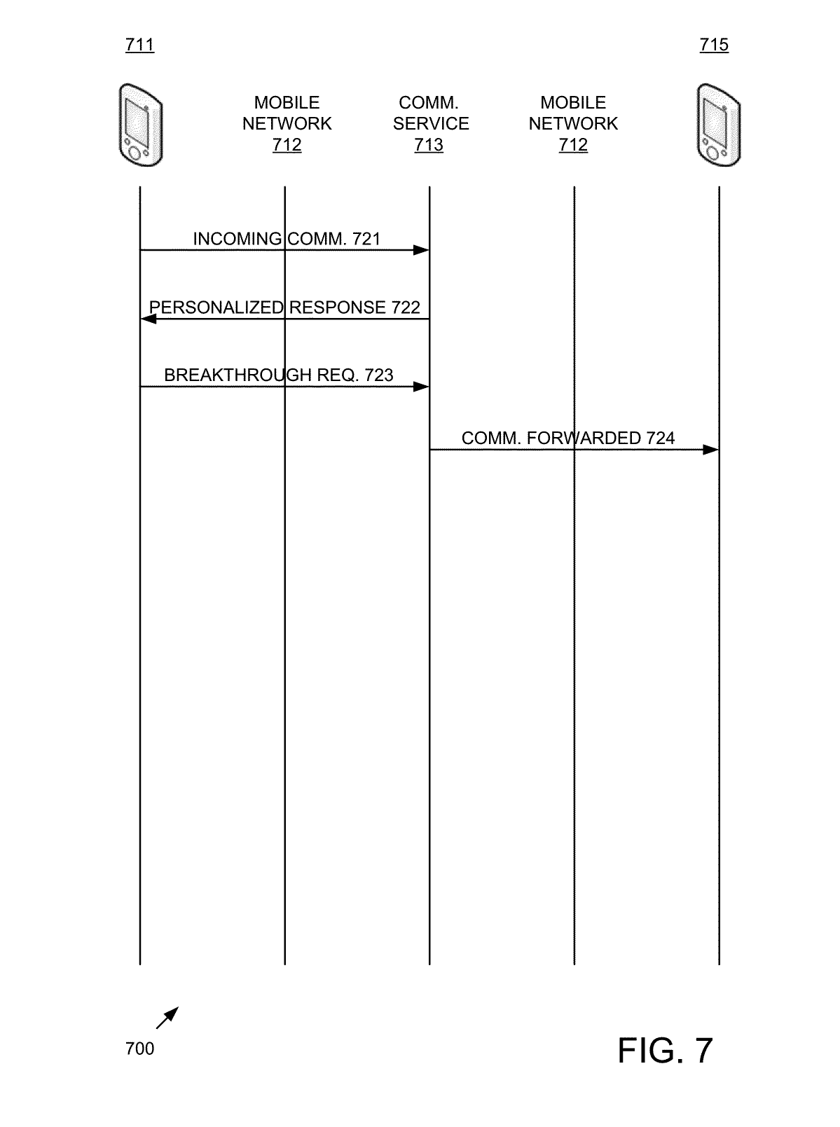

FIG. 7 is messaging diagram 700 showing an implementation of breaking through do-not-disturb status.

In the example, a calling device 711 contacts the communications service 713 via a mobile network (e.g., cellular, GSM, CDMA, or the like), which can forward the call to a serviced (e.g., called) device 715 via the mobile network 712.

At 721, an incoming communication from the calling device 711 directed to the called device 715 is received.

At 722, a personalized response (e.g., greeting) as described herein is provided.

At 723, a breakthrough request from the calling device is received. Such a request can take the form of spoken or text information.

In cases where the calling device has a privileged status, the communication can be forwarded at 724.

In practice, a wide variety of other scenarios other than breaking through can be supported. The communications service can initially choose which action to take based on context, assistant preferences, and information about the caller; post-greeting follow up functionality can be activated by voice, numeric, or text information received from the calling device.

A setting can be provided by which users with sufficient privilege status automatically break through do-not-disturb functionality without going through the personalized greeting or response.

### Example 19

### Exemplary Personalized Greeting for In-Meeting Condition (Not Privileged)

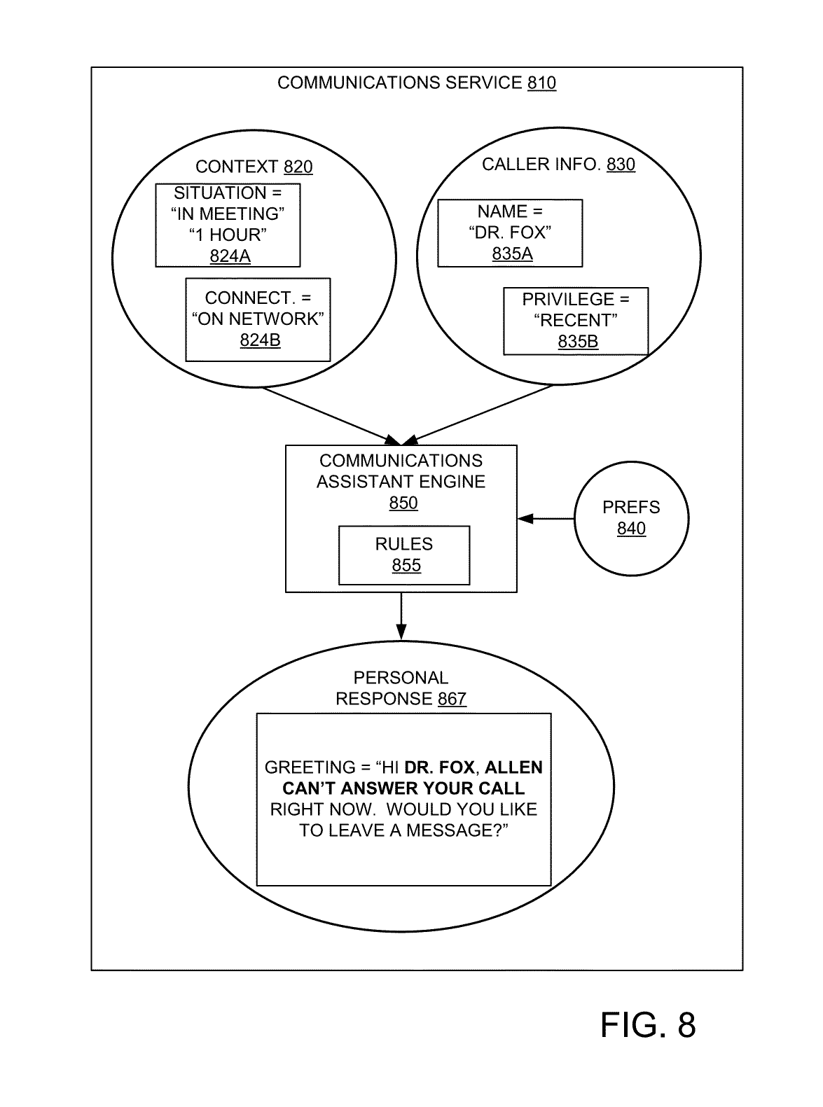

FIG. 8 is a data flow diagram showing formation of a personalized greeting 867 for an in-meeting condition where the caller is not privileged as handled by a communications service 810. In the example, the network-stored context 820 indicates a situation 824A (situation=“in meeting” and duration of “1 hour”) and connectivity status (e.g., “on network”). The calling device information 830 indicates the name 855B for the calling device (“Dr. Fox”) and a privilege status 855B indicating limited privilege (“recent”).

In the example, a personalized greeting 867 includes the name associated with the calling device and a name associated with the called device. Based on detection that the calling device is not associated with a privileged status (e.g., no or insufficient privilege), a generic greeting is provided without further information. An opportunity to leave a message is indicated explicitly in the greeting.

Although the example is shown for an in-meeting status, other do-not-disturb conditions can be similarly supported.

### Example 20

### Exemplary Personalized Greeting for Depleted Battery Condition (Privileged)

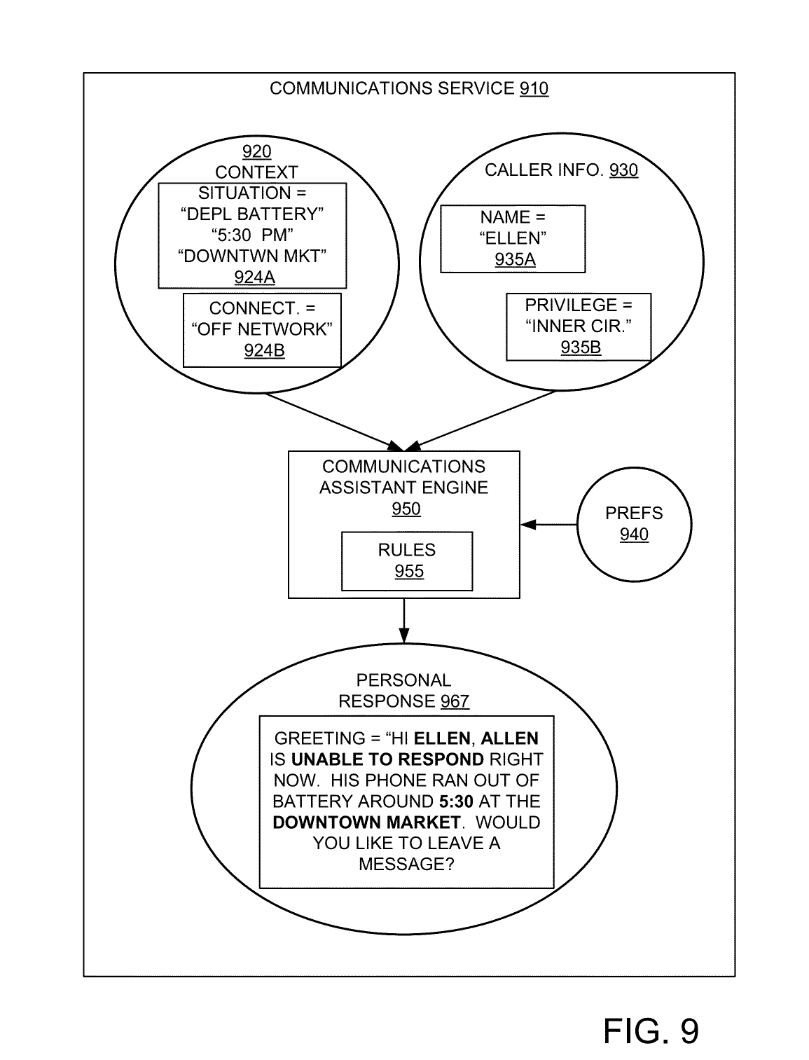

FIG. 9 is a data flow diagram showing formation of a personalized greeting 967 for a depleted battery condition where the caller is privileged as handled by a communications service 910. In the example, the network-stored context 920 indicates a situation 924A (situation=“depleted battery” and time “5:30” and location “downtown market” associated with the last known location of the called device). The calling device information 930 indicates the name 935A for the calling device (“Ellen”) and a privilege status 935B indicating high privilege (“inner circle”).

In any of the examples herein, a depleted battery condition can be communicated to the network from a device by sending a battery condition and current location upon detection that the battery condition is below a threshold (e.g., the device is about to shut down or enter limited communications mode due to lack of sufficient remaining power in the battery).

In the example, a personalized greeting 967 includes the name associated with the calling device and a name associated with the called device. Based on detection that the calling device is associated with a privileged status, additional information, including the depleted battery condition and where and when the battery became depleted are included in the personalized greeting 967. An option to leave a message is also included.

Although the example is shown for a depleted battery condition, other offline conditions can be similarly supported.

### Example 21

### Exemplary Personalized Greeting for Depleted Battery Condition (Not Privileged)

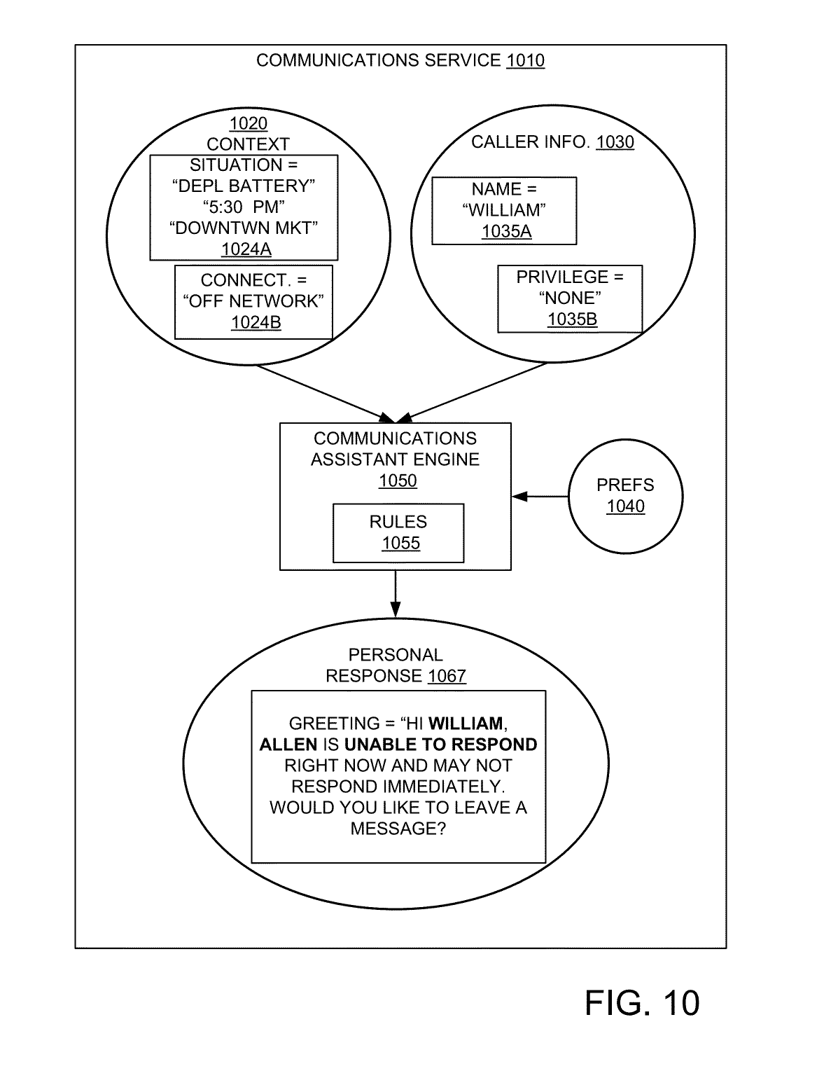

FIG. 10 is a data flow diagram showing formation of a personalized greeting 1067 for a depleted battery condition where the caller is not privileged as handled by a communications service 1010. In the example, the network-stored context 1020 indicates a situation 1024A (situation=“depleted battery” and time “5:30” and location “downtown market” associated with the last known location of the called device). The calling device information 1030 indicates the name 1035A for the calling device (“William”) and a privilege status 1035B indicating no privilege (“none”).

In the example, a personalized greeting 1067 includes the name associated with the calling device and a name associated with the called device. Based on detection that the calling device is not associated with a privileged status, a generic greeting indicating the condition is included without additional information. An option to leave a message is also included.

Although the example is shown for a depleted battery condition, other offline conditions can be similarly supported.

### Example 22

### Exemplary Personalized Greeting for Out-Of-Region Condition

In any of the examples herein, an out-of-region condition can be supported. The network can detect such a condition, or it can be set explicitly by a device. As a result, the network-stored device context can indicate whether the called device is out-of-region. Such a region can be a home calling area, home country, or the like.

Such a features can be helpful if it is desired to block calls due to high roaming or international charges. A personalized greeting can be provided to callers according to caller privilege status and preferences (e.g., “Block all callers when I am out of the country”). The amount of information that a personalized message provides can also be controlled by privilege level (e.g., “Send all callers a generic message”).

When the network-stored context indicates that the called device is in an out-of-region status, the action chosen by the virtual personal operator can be based on such a condition and the action comprises providing a personalized greeting to the calling device indicating an out-of-region status.

A generic message can be a standard voicemail greeting, but additional information indicating the out-of-region condition can be provided according to the caller information and preferences (e.g., “Hi Ellen, Allan is out of the country now and is blocking calls. Please use text or email.”).

Post-greeting follow up functionality as described herein can also be provided based on caller information and preferences (e.g., “Would you like to break through?”).

### Example 23

### Exemplary Explicitly Available Follow up Functionality

In any of the examples herein, a personalized greeting can explicitly present one or more options for selection by the calling user. For example, an option for leaving a voicemail message (“Would you like to leave a message?” “Please leave your message,” or the like) can be presented as part of the greeting.

As described herein, an option for breaking through do-not-disturb status can also be presented. The presence of such an option can be based on detection of a privileged status of the calling device in the network-stored information about the caller.

Other options can be made available, such as the option to dictate a message and send it as a text (e.g., “Would you like me to dictate a message as a text,” “If you like, you can tell me a message, and I will send it as a text to Allen” or the like).

Still other options can be made available, such as to set a reminder for the called device (e.g., the greeting asks, “Would you like to remind Allen to call you back when the meeting is over?” or the like). The reminder (e.g., “Call Ellen.”) can be sent to the called device and subsequently shown at the called device when the meeting is over.

Selection of the appropriate option can be accomplished by receiving an indication of selection. For example, the caller can simply say the option (e.g., “dictate as text”); say “yes” or “no”; say or press the number of the option, or the like.

Other options include adding items to a to-do list, calendar, or the like. For example, if an indication from the calling device is received that a to-do item is to be added for the called device, a message can be queued (e.g., and eventually sent) to the called device for the to-do item. The message results in the to-do item being added to a to-do list of the called device.

In some cases, to reduce the length of the greeting, some options can be abbreviated or left out altogether. In such a case, the options may still be available although not explicitly enumerated (e.g., “Allen is in a meeting. What would you like to do?”).

### Example 24

### Exemplary Post-Greeting Follow Up Functionality

In any of the examples herein, upon selection of an option after presentation of a greeting, post-greeting follow up functionality can be performed. Which functionality is available can be controlled by settings and can depend on whether the calling device has privileged status.

As described herein, do-not-disturb breakthrough functionality can be supported. For example, responsive to receiving an indication of activating the option for breaking through the do-not-disturb status, the incoming call can be forwarded to the called device, thereby breaking thorough the do-not-disturb status.

When a do-not-disturb status (e.g., in-meeting status or the like) is indicated, an option to provide a notification when the status ends can be presented. Responsive to receiving an indication from the calling device to provide a notification on the called device when the condition ends, a message can be queued to the called device. The message results in a notification at the called device when the status ends. The message can be sent at a later time if the device is offline.

Or, for example, a message can be dictated as a text. Upon receiving an indication from the calling device that an option to dictate a message as a text is desired, a dictated message can be received from the calling device, converted to a text, and the text can be sent to the called device. The recognized message can be repeated back to the calling device before confirming that the text is to be sent.

In another example, a reminder can be set for the called device. Upon receiving an indication to set the reminder, a message can be queued to the called device to set a reminder. Such a reminder can include an indication of the calling device and can include a simple narrative or recognized text (e.g., “call Ellen after your meeting,” “don't forget to pick up the widgets,” etc.).

If an indication from the calling device that a reminder is to be added for the called device at a particular time (e.g., “5:00”), a message comprising the particular time can be queued (e.g., and eventually sent) to the called device for the reminder. The message results in the reminder being presented at the called device according to (e.g., for or at) the particular time. The reminder can be stored at the device and acted on (e.g., presented, presented with audio, etc.) at a later time.

In another example, a to-do item can be added to the called device. Upon receiving an indication of the to-do, it can be added by the network to a list of to-do items maintained by the called device. The item can include a simple narrative or recognized text (e.g., “get milk,” “fix the projector,” etc.). Similarly, items can be added to a calendar of the called device.

### Example 25

### Exemplary Emergency Scenario

When a caller repeatedly attempts to contact the called device, an emergency or urgent context variable can be set. Responsive to detection of such a condition, an option to break through the do-not-disturb status due to an emergency can be presented to the caller (e.g., “If this is an emergency, and you want me to break in, please tell me.”) Responsive to activation of the option, break through can be performed. A different minimum privilege status (e.g., lower or none) can be set for emergency break through than that associated with an ordinary break through.

### Example 26

### Exemplary Personalized Greeting for In-Meeting Condition

When an in-meeting condition is detected, an appropriate greeting indicating the meeting can be presented to the calling device (e.g., “Hi Ellen, Allen is in a meeting right now.”) Additional information about the condition (e.g., the condition's projected end time) can be presented based on assistant preferences, privilege status, or the like (e.g., “He'll be out at 3 PM. Should I remind him to call you then?”). The option to set a reminder can also be presented. Responsive to receiving an indication that the reminder is to be set, the reminder can be set as described herein.

The voice-to-text message option can also be presented or be accepted as part of post-greeting follow up (e.g., “Or, I could send him a text message. Just say your message and I'll text it to him”).

### Example 27

### Exemplary Personalized Greeting for Driving Condition

When a driving condition is detected, an appropriate greeting indicating the driving condition can be presented to the calling device (e.g., “It looks like Allen is driving right now.”). Additional information (e.g., the callee's current location) or an option can be presented based on assistant preferences, privilege status, or the like (e.g., “I can send you his current location if you'd like.”). Responsive to receiving an indication that the location is to be sent, the location can be spoken or texted to the caller.

### Example 28

### Exemplary Personalized Greeting for Other Scenarios

The amount of information presented in the personalized greeting can vary according to the privilege status of the caller. For example, for unknown callers, a generic greeting (e.g., “Please leave a message and I'll get back to you”) can be used. For general contacts (e.g., appearing in the contacts of the called device), a more professional greeting can be used (e.g., “Hi Dr. Fox, Allen is not available right now. Would you like to leave a voice message?”). Any number of other scenarios can be supported.

### Example 29

### Exemplary Notifications of Missed Calls

In any of the examples herein, the action chosen (e.g. at 220) by the network can comprise queuing a notification message (e.g., 470) to the called device indicating that a call from the calling device was missed. Such a message can include a name associated with the calling device. Such an action can be chosen based on detecting that the context indicates that the called device is offline. The action can be chosen even if no personalized greeting is provided, or if no voicemail message is left.

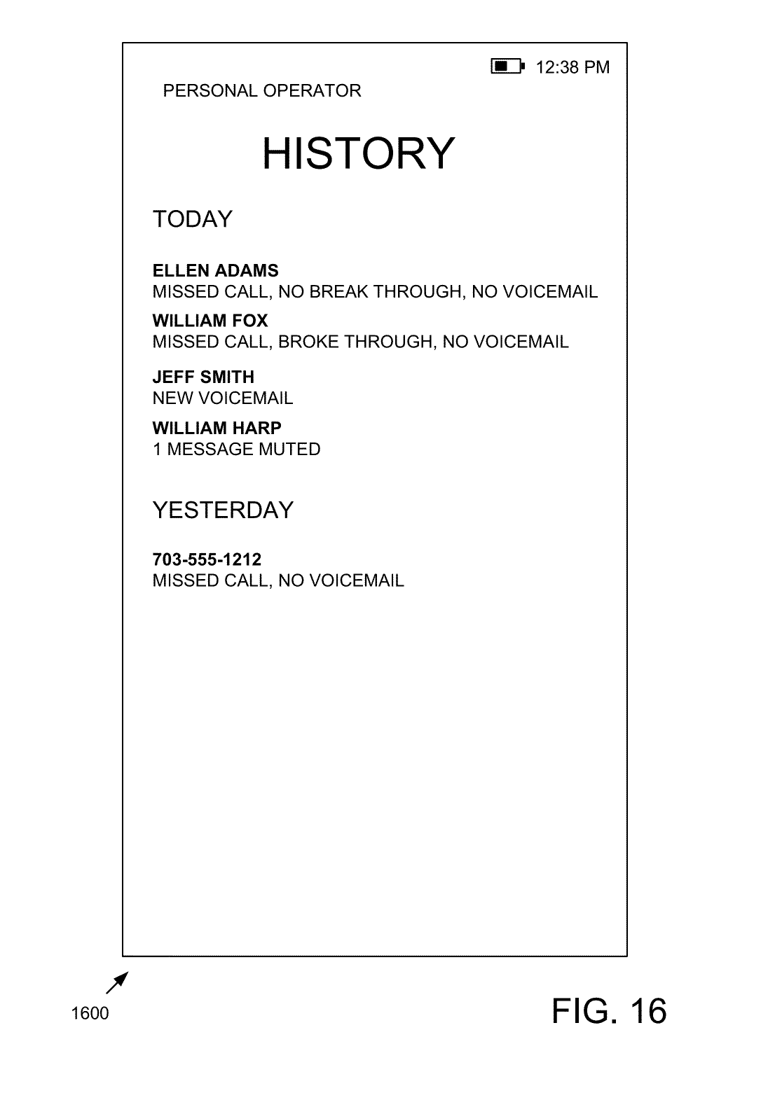

Such a notification can be supported when the called device is offline from the network handling the incoming communication. The notification message can be sent to the called device after the called device comes back online. Such a message is shown in the user interface of FIG. 16 (e.g., “Missed call, no voicemail”).

### Example 30

### Exemplary Notifications of Missed Calls in Noisy Environment

In any of the examples herein, for a missed calls, phone sensor conditions can be evaluated to determine that the call was inadvertently missed. For example, loud ambient surroundings as indicated by the microphone in combination with user inaction (e.g., not pressing ignore or otherwise interacting with the device) imply that missing the call was unintentional (e.g., the called user did not hear the ring). The privilege status of the caller for such calls can be checked (e.g., to see if it is above a user-configurable threshold) to determine whether a call from an important caller was inadvertently missed.

The network can maintain context indicating whether the called device is in a noisy environment. If context indicates that a call from an important caller was inadvertently missed (e.g., the environment was noisy, and the caller had sufficient privilege), a special notification can be provided that waits until a quieter environment is detected (e.g., by checking the microphone at regular or other intervals). Upon detection of the quieter environment, a sound or other notification can be provided at the device to call attention to the missed call. Such an arrangement can be accomplished by a special message (e.g., indicating that a call from an important caller was inadvertently missed and a notification is to be provided after waiting for a quiet environment) sent to the device that triggers such behavior.

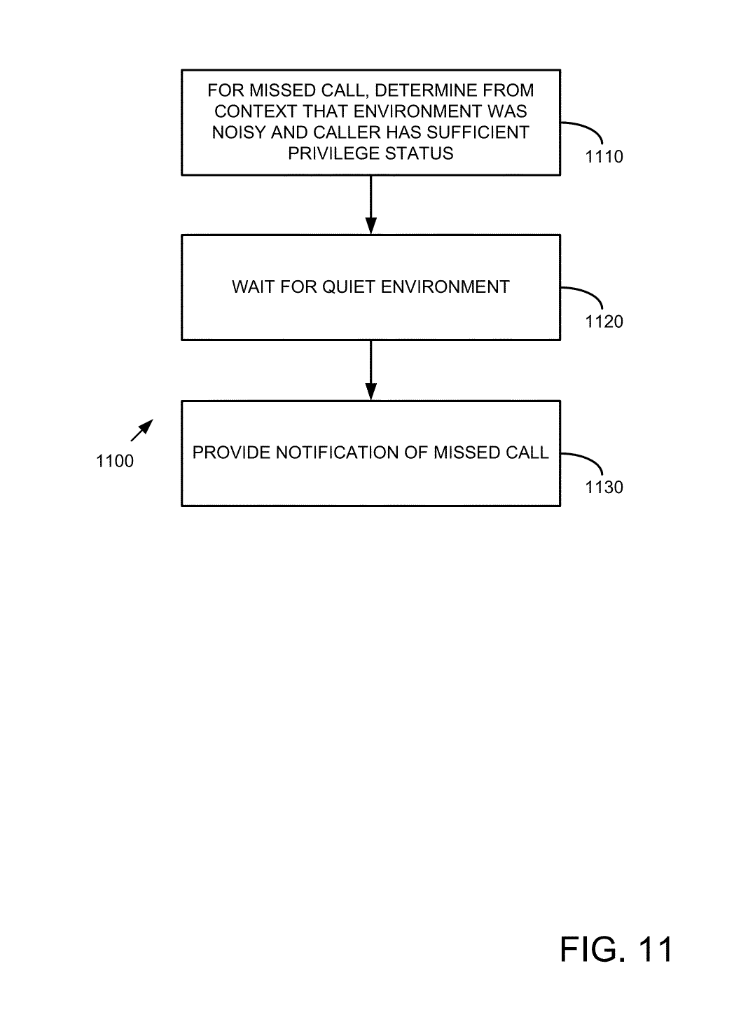

FIG. 11 is a flowchart of an exemplary method 1100 of implementing additional information for privileged calling devices. At 1110, for a missed call, it is determined from context that the called device's environment was noisy and that the caller has sufficient privilege (e.g., is an important caller).

At 1120, the network or called device waits for a quiet environment as described herein.

At 1130, a notification of the missed call is provided as described herein.

Separately, when a call is coming in from an important caller, the ringtone can be escalated to progressively louder if it is detected (e.g., by context stored by the network or otherwise) that the called device is in a loud environment and the incoming call is associated with a contact having sufficient privilege status. A similar action can be taken if it is detected that a called device is in a pocket or purse.

### Example 31

### Exemplary UI for DND Settings

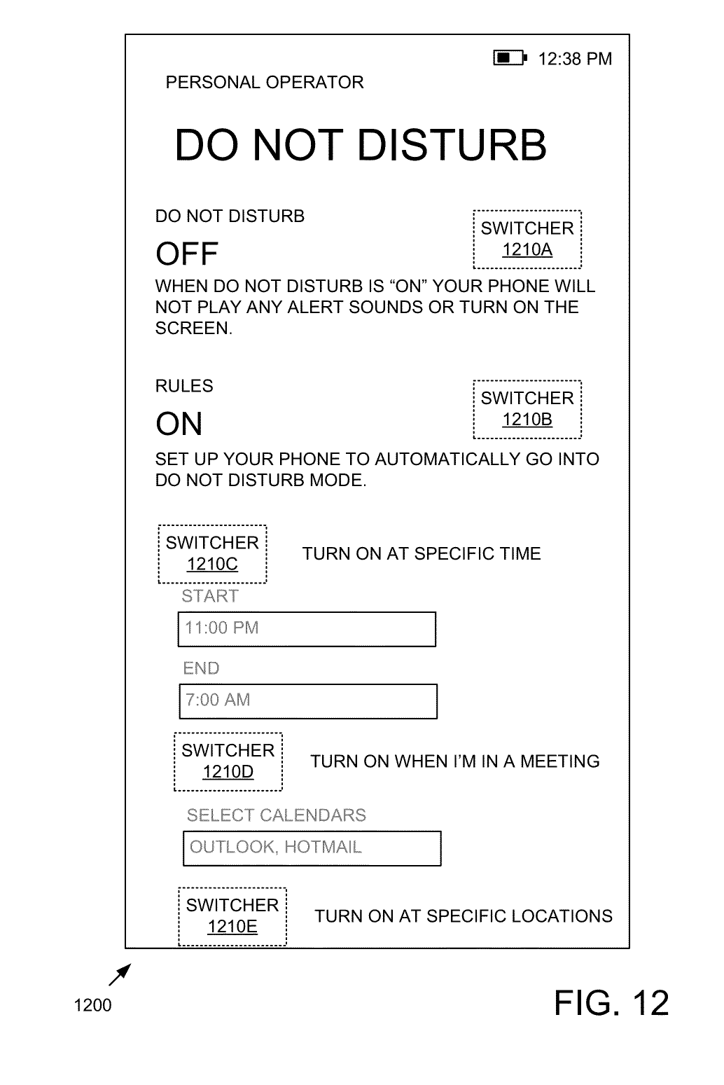

FIG. 12 is a wire frame of an exemplary do-not-disturb settings user interface 1200 for use with the virtual personal operator technologies described herein.

In the example, the user interface can be used to switch do-not-disturb status on and off via a switcher 1210A.

Rules can be activated via switcher 1210B to set up the device to automatically go into do-not-disturb mode. Various factors can be included, such as a specific time range activated via the switcher 1210C, when the user's calendar indicates that they are in a meeting 1210D, when the device is at specific locations 1210E, or the like.

When the device is called, the do-not-disturb status can be indicated outside the device (e.g., stored in the network), so that an appropriate action can be chosen without contacting the device (e.g., even if the device is offline).

### Example 32

### Exemplary UI for Controlling Operation of the Virtual Personal Operator

In any of the examples herein, user interfaces can be presented at a variety of devices. As a result, the network-stored context, contact information, and the like can be managed from any device having connectivity to the network (e.g., through the cloud or the like). For example, a web page can be used to set any of the user preferences described herein, enter contacts, or the like. Such preferences and contact information can then be integrated into the service for use when processing incoming communications.

For example, a user can set do-not-disturb status for a called device from a device other than the called device.

### Example 33

### Exemplary UI for Granting Privileges

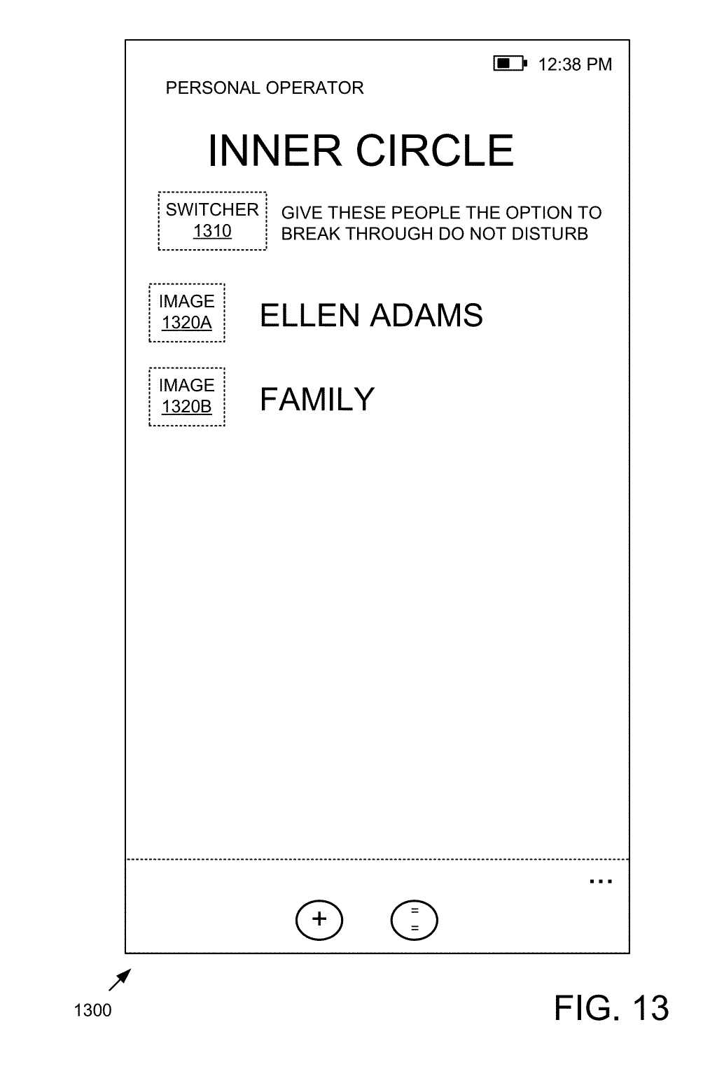

FIG. 13 is a wire frame of an exemplary privilege granting user interface 1300 for use with the virtual personal operator technologies described herein.

In the example, a switcher 1310 can turn on extra options for the listed contacts. In the example, the option to break through do-not-disturb status is depicted. However, other options or whether to present extra information as described herein can be implemented.

The contacts (e.g., associated with images 1320A-B) listed can be managed to add or delete additional contacts.

### Example 34

### Exemplary Contact Card UI for Implementing Privilege Status

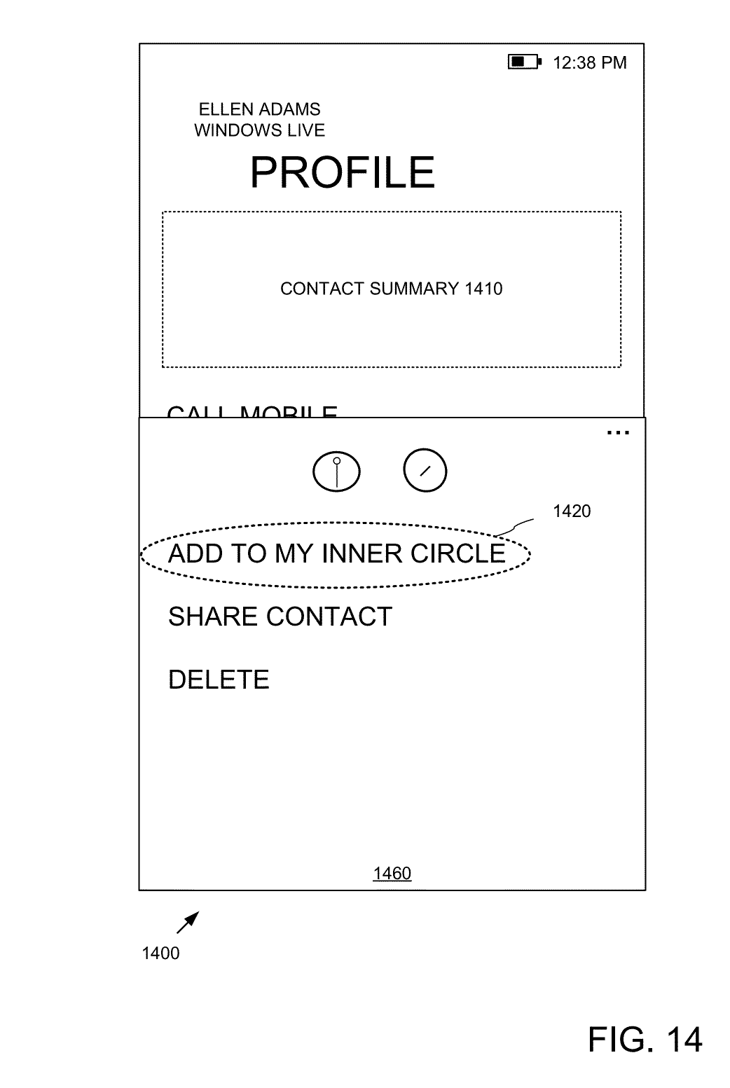

FIG. 14 is a wire frame of an exemplary user interface 1400 for implementing privilege status via a contact card. In the example, when viewing a contact card including a contact summary 1410, additional options 1460 can be displayed. The contact can be awarded a particular privilege status by selecting an appropriate option 1420. The status can then be communicated to the network.

### Example 35

### Exemplary UI for Personalized Greeting Settings

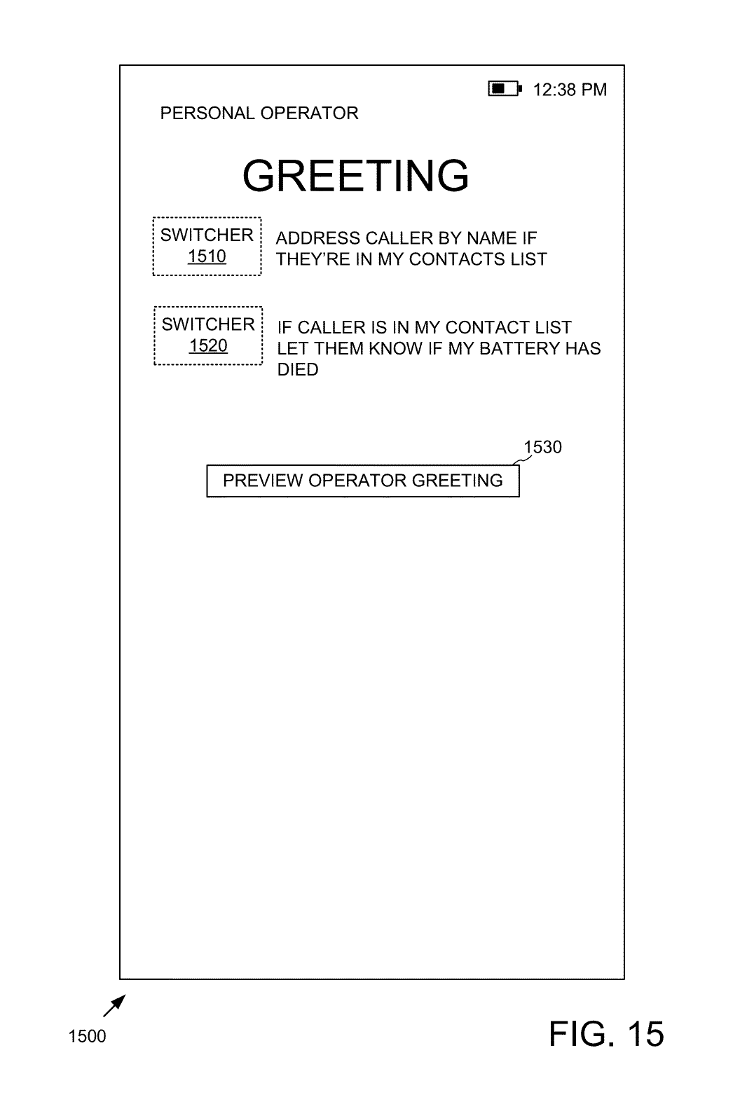

FIG. 15 is a wire frame of an exemplary personalized greeting settings user interface 1500 for use with the virtual personal operator technologies described herein.

In the example, a switcher 1510 controls whether callers are addressed by name if the calling device has a number appearing in the contacts for the device (e.g., which are also stored in the network).

A switcher 1520 controls whether callers are told that the device battery has been depleted.

Although specific examples are shown, a generic setting (e.g., “provide more information”) can be provided for different types of calling devices (e.g., privileged, in contacts list, recently called, or the like).

An option 1530 to preview the operator greeting can be provided. Responsive to activation of the option 1530, the operator greeting can be played by the device (e.g., including a name associated with a user of the device).

### Example 36

### Exemplary UI for Notifications

FIG. 16 is a wire frame of an exemplary call history user interface 1600 including notifications generated via the virtual personal operator technologies described herein.

In the example, responsive to incoming communications activity, an entry is placed in the call history showing the calling party (e.g., as determined by the calling number) and the action(s) that were taken. Such actions can include breakthrough attempts, successful breakthrough, muted messages, combinations thereof, and the like. Negative conditions (e.g., “no breakthrough”) can also be included. The call history can be maintained by the network so that actions taken when the device is offline can still be reflected accurately in the call history. A local copy can be stored and synced to the network copy.

Implementations can vary. For example, breakthrough attempts can be shown or not shown as desired.

In the example, a notification of a missed call can be included, even if the device is offline (e.g., due to lack of network connectivity, depleted battery, etc.) or in do-not-disturb status at the time of the call.

### Example 37

### Exemplary UI for Text Message DND Breakthrough

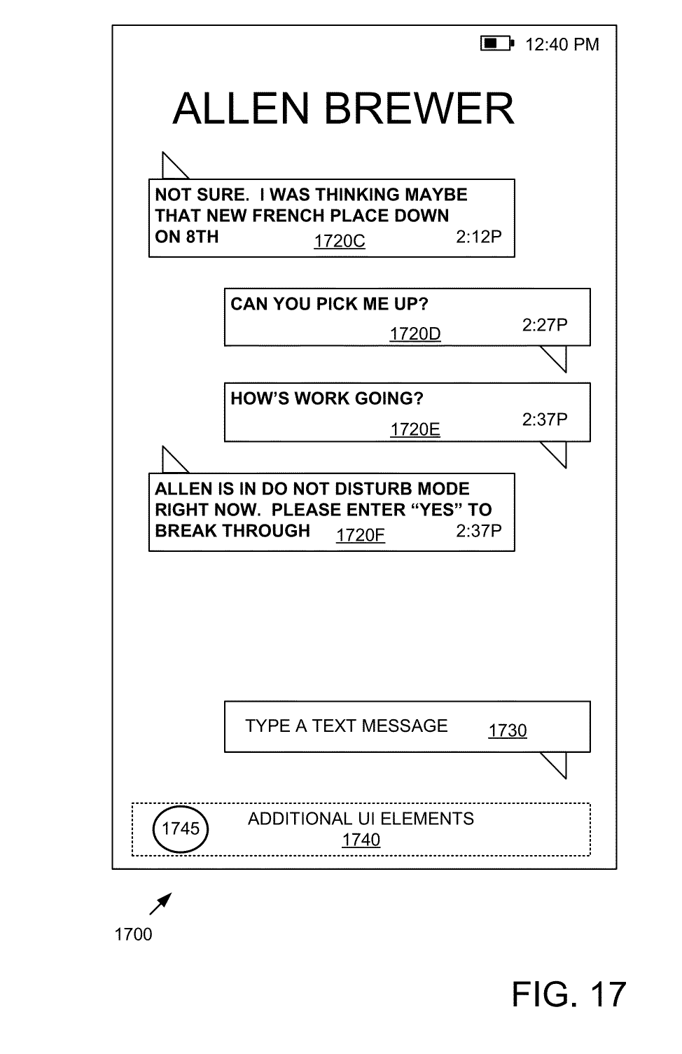

FIG. 17 is a wire frame of an exemplary text message user interface 1700 implementing do-not-disturb breakthrough. In the example, the device presenting the interface 1700 is unserviced by the virtual personal operator technologies described herein, but the texted device is serviced.

A series of text messages 1720C-E in a conversation are shown.

When it is detected that the texted device is in do-not-disturb status, a personalized greeting 1720F is presented including an option to break through do-not-disturb status. Upon detection of an appropriate response 1730 activating the breakthrough option (e.g., “Yes”), the text message is sent. An appropriate alert (e.g., sound) or the like can be caused at the texted device.

Additional user interface elements 1740, 1745 can be presented as part of the text user interface.

A similar scenario can be supported for offline condition similar to that for voice callers (e.g., an auto reply text can be sent with information). Levels of information and options can be controlled based on privileges. For example, if a user at the called device is unavailable (e.g., the device is offline or in do-not-disturb status), a text message can be sent to the calling device indicating unavailability. Post-greeting follow up functionality can also be provided via text message as described herein.

### Example 38

### Exemplary Table for Implementing Privilege Status

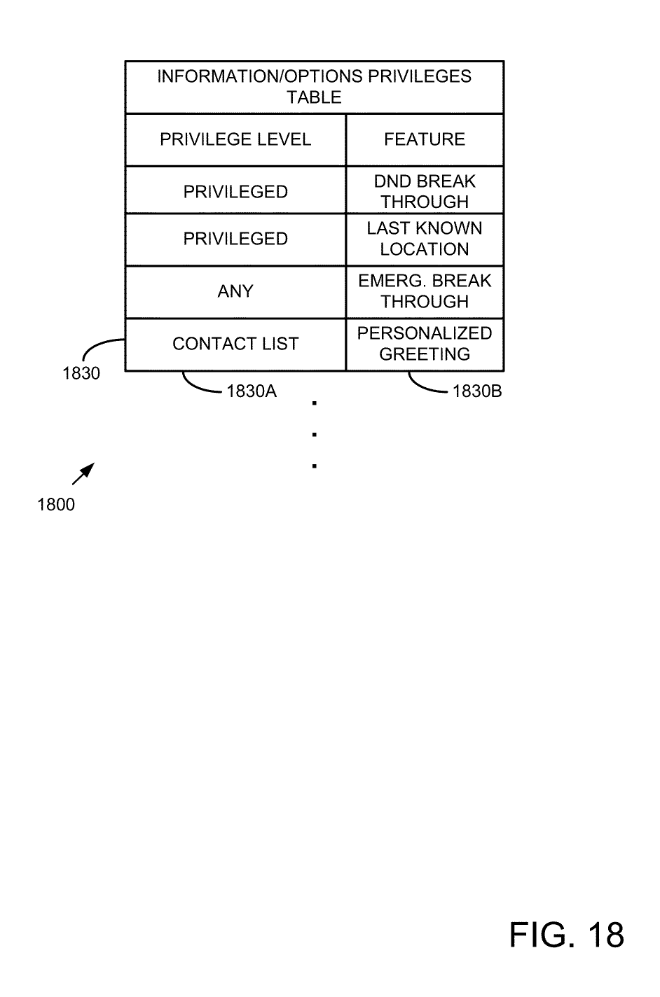

FIG. 18 is a block diagram of an exemplary table 1800 showing available features according to privilege level. In the example, a table entry 1830 includes a privilege level 1830A and a feature 1830B. The table can be maintained in the network and indicate which calling devices are provided which features by the virtual personal operator as described herein.

Responsive to detecting that a calling device has sufficient privileges as indicated in the table 1800, the functionality indicated in the table 1800 can be provided.

### Example 39

### Exemplary Communications

In any of the examples herein, supported communication types can comprise calling, messaging, or the like. A call can be a voice call, video call, or the like. Messaging can take the form of text messaging, SMS messaging, MMS messaging, OTT messaging, or the like and can also support extended content (e.g., audio, video, image, or the like). OTT messaging can involve any third party communication application supported by the device and network (e.g., social network messaging, VoIP communications, or the like).

Engaging in such communication can comprise placing or receiving a call, sending or displaying a text message, or the like. Numbers can include telephone numbers or other codes used to place a call. User addresses can include social network addresses or other codes used to send a message.

### Example 40

### Exemplary Computing Systems

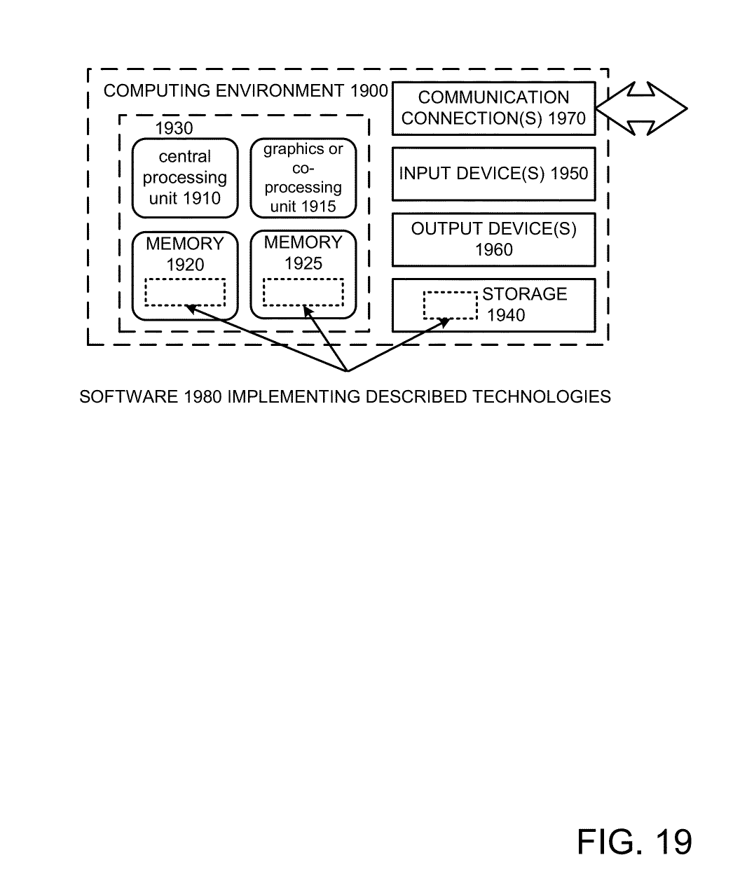

FIG. 19 illustrates a generalized example of a suitable computing system or environment 1900 in which several of the described innovations may be implemented. The computing system 1900 is not intended to suggest any limitation as to scope of use or functionality, as the innovations may be implemented in diverse general-purpose or special-purpose computing systems. A communications device as described herein can take the form of the described computing system 1900.

With reference to FIG. 19, the computing system 1900 includes one or more processing units 1910, 1915 and memory 1920, 1925. In FIG. 19, this basic configuration 1930 is included within a dashed line. The processing units 1910, 1915 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 19 shows a central processing unit 1910 as well as a graphics processing unit or co-processing unit 1915. The tangible memory 1920, 1925 may be volatile memory (e.g., registers, cache, RAM), nonvolatile memory (e.g., ROM, EEPROM, flash memory, etc.), or some combination of the two, accessible by the processing unit(s). The memory 1920, 1925 stores software 1980 implementing one or more innovations described herein, in the form of computer-executable instructions suitable for execution by the processing unit(s).

A computing system may have additional features. For example, the computing system 1900 includes storage 1940, one or more input devices 1950, one or more output devices 1960, and one or more communication connections 1970. An interconnection mechanism (not shown) such as a bus, controller, or network interconnects the components of the computing system 1900. Typically, operating system software (not shown) provides an operating environment for other software executing in the computing system 1900, and coordinates activities of the components of the computing system 1900.

The tangible storage 1940 may be removable or non-removable, and includes magnetic disks, magnetic tapes or cassettes, CD-ROMs, DVDs, or any other medium which can be used to store information in a non-transitory way and which can be accessed within the computing system 1900. The storage 1940 stores instructions for the software 1980 implementing one or more innovations described herein.

The input device(s) 1950 may be a touch input device such as a keyboard, mouse, pen, or trackball, a voice input device, a scanning device, or another device that provides input to the computing system 1900. For video encoding, the input device(s) 1950 may be a camera, video card, TV tuner card, or similar device that accepts video input in analog or digital form, or a CD-ROM or CD-RW that reads video samples into the computing system 1900. The output device(s) 1960 may be a display, printer, speaker, CD-writer, or another device that provides output from the computing system 1900.

The communication connection(s) 1970 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-readable media. Computer-readable media are any available tangible media that can be accessed within a computing environment. By way of example, and not limitation, with the computing system 1900, computer-readable media include memory 1920, 1925, storage 1940, and combinations of any of the above.

The innovations can be described in the general context of computer-executable instructions, such as those included in program modules, being executed in a computing system on a target real or virtual processor (e.g., which is ultimately executed in hardware). Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 41

### Exemplary Mobile Device

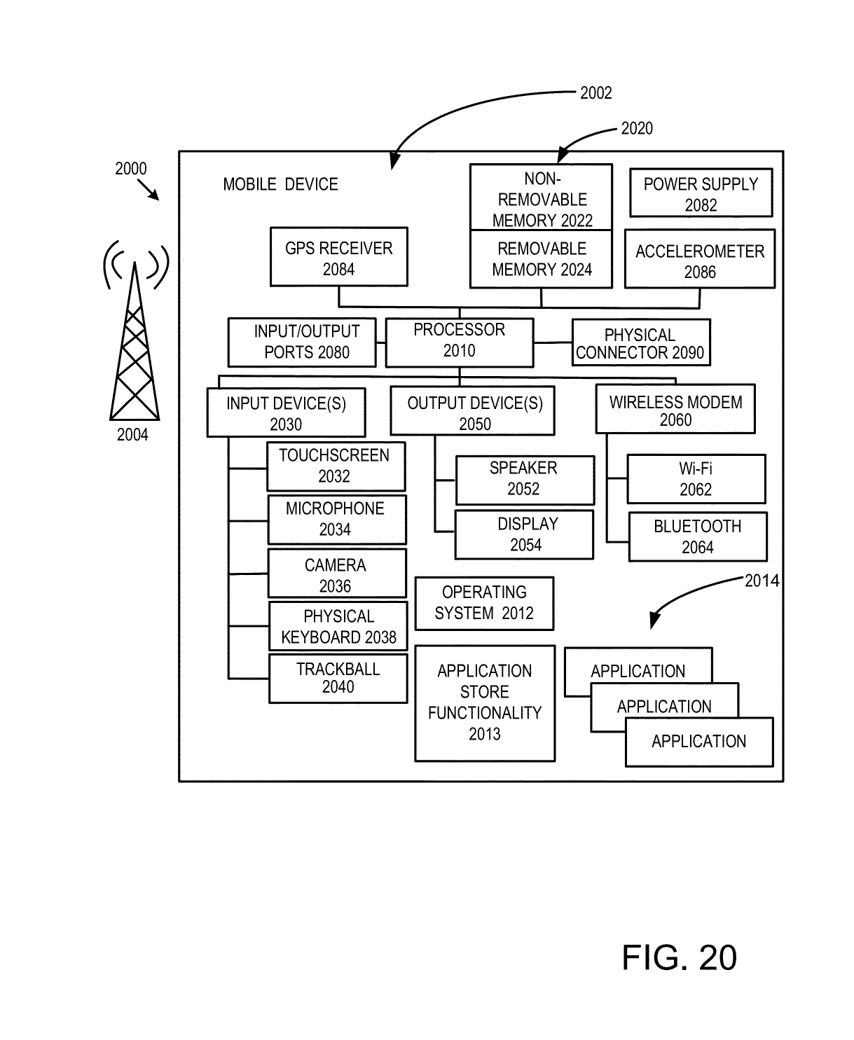

FIG. 20 is a system diagram depicting an exemplary mobile device 2000 including a variety of optional hardware and software components, shown generally at 2002. Any components 2002 in the mobile device can communicate with any other component, although not all connections are shown, for ease of illustration. The mobile device can be any of a variety of computing devices (e.g., cell or other mobile phone, smartphone, handheld computer, Personal Digital Assistant (PDA), etc.) and can allow wireless two-way communications with one or more mobile communications networks 2004, such as a cellular, mobile, satellite, or other network. Voice over IP scenarios (e.g., over WiFi or other network) can also be supported. The communication devices described herein can take the form of the described mobile device 2000.

The illustrated mobile device 2000 can include a controller or processor 2010 (e.g., signal processor, microprocessor, ASIC, or other control and processing logic circuitry) for performing such tasks as signal coding, data processing, input/output processing, power control, and/or other functions. An operating system 2012 can control the allocation and usage of the components 2002 and support for one or more application programs 2014. The application programs 2014 can include common mobile computing applications (e.g., email applications, calendars, contact managers, web browsers, messaging applications), or any other computing application. Functionality 2013 for accessing an application store can also be used for acquiring and updating applications 2014.

The illustrated mobile device 2000 can include memory 2020. Memory 2020 can include non-removable memory 2022 and/or removable memory 2024. The non-removable memory 2022 can include RAM, ROM, flash memory, a hard disk, or other well-known memory storage technologies. The removable memory 2024 can include flash memory or a Subscriber Identity Module (SIM) card, which is well known in GSM communication systems, or other well-known memory storage technologies, such as “smart cards.” The memory 2020 can be used for storing data and/or code for running the operating system 2012 and the applications 2014. Example data can include web pages, text, images, sound files, video data, or other data sets to be sent to and/or received from one or more network servers or other devices via one or more wired or wireless networks. The memory 2020 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 2000 can support one or more input devices 2030, such as a touch screen 2032, microphone 2034, camera 2036, physical keyboard 2038 and/or trackball 2040 and one or more output devices 2050, such as a speaker 2052 and a display 2054. Other possible output devices (not shown) can include piezoelectric or other haptic output devices. Some devices can serve more than one input/output function. For example, touchscreen 2032 and display 2054 can be combined in a single input/output device.

A wireless modem 2060 can be coupled to an antenna (not shown) and can support two-way communications between the processor 2010 and external devices, as is well understood in the art. The modem 2060 is shown generically and can include a cellular modem for communicating with the mobile communication network 2004 and/or other radio-based modems (e.g., Bluetooth 2064 or Wi-Fi 2062). The wireless modem 2060 is typically configured for communication with one or more cellular networks, such as a GSM or CDMA network for data and voice communications within a single cellular network, between cellular networks, or between the mobile device and a public switched telephone network (PSTN).

The mobile device 2000 can further include at least one input/output port 2080, a power supply 2082, a satellite navigation system receiver 2084, such as a Global Positioning System (GPS) receiver, an accelerometer 2086, and/or a physical connector 2090, which can be a USB port, IEEE 1394 (FireWire) port, and/or RS-232 port. The illustrated components 2002 are not required or all-inclusive, as any components can deleted and other components can be added.

### Example 42

### Exemplary Cloud-Supported Environment

In example environment 2100, the cloud 2110 provides services for connected devices 2130, 2140, 2150 with a variety of screen capabilities. Connected device 2130 represents a device with a computer screen 2135 (e.g., a mid-size screen). For example, connected device 2130 could be a personal computer such as desktop computer, laptop, notebook, netbook, or the like. Connected device 2140 represents a device with a mobile device screen 2145 (e.g., a small size screen). For example, connected device 2140 could be a mobile phone, smart phone, personal digital assistant, tablet computer, and the like. Connected device 2150 represents a device with a large screen 2155. For example, connected device 2150 could be a television screen (e.g., a smart television) or another device connected to a television (e.g., a set-top box or gaming console) or the like. One or more of the connected devices 2130, 2140, 2150 can include touch screen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 2100. For example, the cloud 2110 can provide services for one or more computers (e.g., server computers) without displays.

Services can be provided by the cloud 2110 through service providers 2120, or through other providers of online services (not depicted). For example, cloud services can be customized to the screen size, display capability, and/or touch screen capability of a particular connected device (e.g., connected devices 2130, 2140, 2150).

In example environment 2100, the cloud 2110 provides the technologies and solutions described herein to the various connected devices 2130, 2140, 2150 using, at least in part, the service providers 2120. For example, the service providers 2120 can provide a centralized solution for various cloud-based services. The service providers 2120 can manage service subscriptions for users and/or devices (e.g., for the connected devices 2130, 2140, 2150 and/or their respective users).

### Example 43

### Exemplary Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., non-transitory computer-readable media, such as one or more optical media discs, volatile memory components (such as DRAM or SRAM), or nonvolatile memory components (such as hard drives)) and executed on a computer (e.g., any commercially available computer, including smart phones or other mobile devices that include computing hardware). Any of the computer-executable instructions for implementing the disclosed techniques as well as any data created and used during implementation of the disclosed embodiments can be stored on one or more computer-readable media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

### Non-Transitory Computer-Readable Media

Any of the computer-readable media herein can be non-transitory (e.g., memory, magnetic storage, optical storage, or the like).

### Storing in Computer-Readable Media

Any of the storing actions described herein can be implemented by storing in one or more computer-readable media (e.g., computer-readable storage media or other tangible media).

Any of the things described as stored can be stored in one or more computer-readable media (e.g., computer-readable storage media or other tangible media).

### Methods in Computer-Readable Media

Any of the methods described herein can be implemented by computer-executable instructions in (e.g., encoded on) one or more computer-readable media (e.g., computer-readable storage media or other tangible media). Such instructions can cause a computer to perform the method. The technologies described herein can be implemented in a variety of programming languages.

### Methods in Computer-Readable Storage Devices

Any of the methods described herein can be implemented by computer-executable instructions stored in one or more computer-readable storage devices (e.g., memory, magnetic storage, optical storage, or the like). Such instructions can cause a computer to perform the method.

### OTHER EMBODIMENTS

Clause 1. A method implemented at least in part by a computing system, the method comprising:

responsive to detection of an incoming communication directed from a calling device to a called device, based on a network-stored context derived from the called device, network-stored assistant preferences derived from the called device, or network-stored information about the calling device, choosing an action for the incoming communication; and

performing the chosen action for the incoming communication.

Clause 2. The method of clause 1 wherein the incoming communication comprises an incoming phone call or incoming text message.

Clause 3. The method of clause 2 wherein choosing the action comprises choosing from alternatives comprising:

providing a personalized greeting to the calling device; and

forwarding the incoming communication to the called device.

Clause 4. The method of clause 3 wherein:

the network-stored context derived from the called device indicates that the called device is in a do-not-disturb status;

choosing the action is based on that the network-stored context derived from the called device indicates that the called device is in a do-not-disturb status; and

choosing the action comprises providing a personalized greeting to the calling device.

Clause 5. The method of clause 4 wherein:

the network-stored information about the calling device indicates that the calling device is a privileged calling device; and

the method further comprises:

based on detecting that the network-stored information indicates that the calling device is a privileged calling device, including an option in the personalized greeting for breaking through the do-not-disturb status.

Clause 6. The method of clause 5 further comprising:

receiving an indication of activating the option for breaking through the do-not-disturb status; and

responsive to the indication, forwarding the incoming phone call to the called device, thereby breaking through the do-not-disturb status.

Clause 7. The method of clause 6 further comprising:

inferring do-not-disturb status for the called device based on a condition selected from the group consisting of:

detection of an in-meeting condition in the network-stored context;

detection of driving condition in the network-stored context;

detection of airplane mode in the network-stored context;

detection of a callee-is-sleeping condition in the network-stored context; and

detection of an at-work condition in the network-stored context.

Clause 8. The method of clause 7 further comprising:

including an indication of the detected condition in the personalized greeting.

Clause 9. The method of clause 8 further comprising:

verifying that an assistant preference indicates that situational information is to be provided to callers; and

including the indication of the detected condition is performed responsive to the verifying.

Clause 10. The method of any of clauses 1-9 further comprising:

based on the network-stored information about the calling device, including a spoken name associated with the calling device in the personalized greeting.

Clause 11. The method of any of clauses 1-10 further comprising:

after presenting the personalized greeting, receiving activation of post-greeting follow up functionality by the calling device; and

responsive to the activation, performing the post-greeting follow up functionality.

Clause 12. The method of any of clauses 1-11 wherein:

the personalized greeting comprises indications of options for:

leaving a message;

dictating a message and send as a text; and

breaking through do-not-disturb status;

wherein presence of the option for breaking through do-not-disturb status is based on detection of a privileged status of the calling device in the network-stored information about the calling device.

Clause 13. The method of any of clauses 1-12 further comprising:

receiving an indication from the calling device that an option to dictate a message as a text is desired;

converting a dictated message from the calling device as a text; and

sending the text to the called device.

Clause 14. The method of any of clauses 1-14 further comprising:

determining a privilege status of the calling device in the network-stored information about the calling device; and

responsive to determining that the calling device has a privileged status, including additional information or an option in the personalized greeting.

Clause 15. The method of clause 14 wherein the option comprises:

an option to break through do-not-disturb status.

Clause 16. The method of any of clauses 14-15 wherein the additional information comprises:

an indication of an in-meeting condition; and

an indication of when the in-meeting condition ends.

Clause 17. The method of clause 16 further comprising:

receiving an indication from the calling device to provide a notification on the called device when the in-meeting condition ends; and

responsive to receiving the indication to provide the notification, queuing a message to the called device, wherein the message results in a notification at the called device when the in-meeting condition ends.

Clause 18. The method of any of clauses 14-17 further comprising:

receiving an indication from the calling device that a to-do item is to be added for the called device; and

sending a message to the called device for the to-do item, wherein the message results in the to-do item being added to a to-do list of the called device.

Clause 19. The method of any of clauses 14-18 further comprising:

receiving an indication from the calling device that a reminder is to be added for the called device at a particular time; and

responsive to receiving the indication, sending a message comprising the particular time to the called device for the reminder, wherein the message results in the reminder being presented at the called device according to the particular time.

Clause 20. The method of any of clauses 14-19 wherein the additional information comprises:

an indication of a driving condition.

Clause 21. The method of any of clauses 14-20 wherein the additional information comprises:

an indication that a battery of the called device is not supporting normal communications; and

an indication of a last known location of the called device.

Clause 22. The method of any of clauses 1-21 wherein:

the network-stored context indicates that the called device is in an out-of-region status;

choosing the action is based on that the network-stored context indicates that the called device is in an out-of-region status; and

the action comprises providing a personalized greeting to the calling device indicating an out-of-region status.

Clause 23. The method of any of clauses 1-22 wherein:

the chosen action comprises forwarding the incoming communication to another device at which a user identity associated with the called device is detected as present instead of the called device.

Clause 24. The method of any of clauses 1-23 wherein:

the chosen action comprises sending a text message to the calling device indicating unavailability of a user at the called device.

Clause 25. The method of any of clauses 1-24 wherein:

the network-stored context indicates that the called device is in a noisy environment; and

the chosen action comprises sending a message to the called device indicating that a call from an important caller was inadvertently missed and that a notification is to be provided after waiting for a quiet environment.

Clause 26. The method of any of clauses 1-25 wherein:

the chosen action comprises queuing a notification message to the called device indicating that a call from the calling device was missed.

Clause 27. The method of clause 26 wherein:

the called device is offline from a network handling the incoming communication; and

the notification message is sent to the called device after the called device comes back online.

### Alternatives

The technologies from any example can be combined with the technologies described in any one or more of the other examples. Where the word “exemplary” is used, it is intended to indicate an example and not an ideal embodiment. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. We therefore claim as our invention all that comes within the scope and spirit of the claims.

What is claimed is:

1. A method implemented at least in part by a computing system, the method comprising:
responsive to detection of an incoming communication directed from a calling device to a called device, based on a network-stored context derived from the called device, network-stored assistant preferences derived from the called device, or network-stored information about the calling device, choosing an action for the incoming communication; and
performing the chosen action for the incoming communication.

2. The method of claim 1 wherein the incoming communication comprises an incoming phone call or incoming text message.

3. The method of claim 2 wherein choosing the action comprises choosing from alternatives comprising:
providing a personalized greeting to the calling device; and
forwarding the incoming communication to the called device.

4. The method of claim 3 wherein:
the network-stored context derived from the called device indicates that the called device is in a do-not-disturb status;
choosing the action is based on that the network-stored context derived from the called device indicates that the called device is in a do-not-disturb status; and
choosing the action comprises providing a personalized greeting to the calling device.

5. The method of claim 4 wherein:
the network-stored information about the calling device indicates that the calling device is a privileged calling device; and
the method further comprises:
based on detecting that the network-stored information indicates that the calling device is a privileged calling device, including an option in the personalized greeting for breaking through the do-not-disturb status.

6. The method of claim 5 further comprising:
receiving an indication of activating the option for breaking through the do-not-disturb status; and
responsive to the indication, forwarding the incoming phone call to the called device, thereby breaking through the do-not-disturb status.

7. The method of claim 6 further comprising:
inferring do-not-disturb status for the called device based on a condition selected from the group consisting of:
detection of an in-meeting condition in the network-stored context;
detection of driving condition in the network-stored context;
detection of airplane mode in the network-stored context;
detection of a callee-is-sleeping condition in the network-stored context; and
detection of an at-work condition in the network-stored context.

8. The method of claim 7 further comprising:
including an indication of the detected condition in the personalized greeting.

9. The method of claim 8 further comprising:
verifying that an assistant preference indicates that situational information is to be provided to callers; and
including the indication of the detected condition is performed responsive to the verifying.

10. The method of claim 3 further comprising:
based on the network-stored information about the calling device, including a spoken name associated with the calling device in the personalized greeting.

11. The method of claim 3 further comprising:
after presenting the personalized greeting, receiving activation of post-greeting follow up functionality by the calling device; and
responsive to the activation, performing the post-greeting follow up functionality.

12. The method of claim 3 wherein:
the personalized greeting comprises indications of options for:
leaving a message;
dictating a message and send as a text; and
breaking through do-not-disturb status;
wherein presence of the option for breaking through do-not-disturb status is based on detection of a privileged status of the calling device in the network-stored information about the calling device.

13. The method of claim 3 further comprising:
receiving an indication from the calling device that an option to dictate a message as a text is desired;
converting a dictated message from the calling device as a text; and
sending the text to the called device.

14. The method of claim 3 further comprising:
determining a privilege status of the calling device in the network-stored information about the calling device; and
responsive to determining that the calling device has a privileged status, including additional information or an option in the personalized greeting.

15. The method of claim 14 wherein the option comprises:
an option to break through do-not-disturb status.

16. The method of claim 14 wherein the additional information comprises:
an indication of an in-meeting condition; and
an indication of when the in-meeting condition ends.

17. The method of claim 16 further comprising:
receiving an indication from the calling device to provide a notification on the called device when the in-meeting condition ends; and
responsive to receiving the indication to provide the notification, queuing a message to the called device, wherein the message results in a notification at the called device when the in-meeting condition ends.

18. The method of claim 14 further comprising:
receiving an indication from the calling device that a to-do item is to be added for the called device; and
sending a message to the called device for the to-do item, wherein the message results in the to-do item being added to a to-do list of the called device.

19. The method of claim 14 further comprising:
receiving an indication from the calling device that a reminder is to be added for the called device at a particular time; and
responsive to receiving the indication, sending a message comprising the particular time to the called device for the reminder, wherein the message results in the reminder being presented at the called device according to the particular time.

20. The method of claim 14 wherein the additional information comprises:
an indication of a driving condition.

21. The method of claim 14 wherein the additional information comprises:
an indication that a battery of the called device is not supporting normal communications; and
an indication of a last known location of the called device.

22. The method of claim 3 wherein:
the network-stored context indicates that the called device is in an out-of-region status;
choosing the action is based on that the network-stored context indicates that the called device is in an out-of-region status; and
the action comprises providing a personalized greeting to the calling device indicating an out-of-region status.

23. The method of claim 1 wherein:
the chosen action comprises forwarding the incoming communication to another device at which a user identity associated with the called device is detected as present instead of the called device.

24. The method of claim 1 wherein:
the chosen action comprises sending a text message to the calling device indicating unavailability of a user at the called device.

25. The method of claim 1 wherein:
the network-stored context indicates that the called device is in a noisy environment; and
the chosen action comprises sending a message to the called device indicating that a call from an important caller was inadvertently missed and that a notification is to be provided after waiting for a quiet environment.

26. The method of claim 1 wherein:
the chosen action comprises queuing a notification message to the called device indicating that a call from the calling device was missed.

27. The method of claim 26 wherein:
the called device is offline from a network handling the incoming communication; and
the notification message is sent to the called device after the called device comes back online.

28. The method of claim 1 further comprising:
prior to processing the incoming communication, deriving the network-stored context from the called device, wherein the context comprises one or more chosen from the group consisting of:
a location of the called device;
a do-not-disturb status of the called device;
an in-meeting status; and
an is-driving status.

29. A system comprising:
a processor;
memory coupled to the processor; and
a personal communications assistant engine coupled to a mobile device context for a mobile device stored outside of the mobile device, calendar information for the mobile device stored outside of the mobile device, and contact information for the mobile device stored outside of the mobile device;
wherein the personal communications assistant engine is configured to:
determine that the mobile device is in a do-not-disturb status;
assemble a personalized greeting to a calling device indicating the do-not-disturb status;
determine that the calling device has a privileged status; and
include additional information in the personalized greeting based on the privileged status of the calling device.

30. One or more computer-readable storage media comprising computer-executable instructions causing a computer to perform a method comprising:
responsive to an indication of an incoming call from a calling device to a called device, based on a stored context derived from the called device, the context indicating that the called device is in a do-not-disturb status, intercepting the incoming call;
detecting that the incoming call is coming from a device indicated as having a privileged status in a contacts list stored remotely from the called device;
generating a personalized greeting based on the stored context derived from the called device, wherein the generating comprises, responsive to detecting that the incoming call is coming from a device indicated as having a privileged status, including an option to break through the do-not-disturb status, and the generating comprises including a name associated with the calling device in the contacts list stored remotely from the called device;
sending the personalized greeting to the calling device, wherein the personalized greeting comprises the option to break through the do-not-disturb status and the name associated with the calling device in the contacts list stored remotely from the called device;
receiving an indication from the calling device that the option to break through the do-not-disturb status has been activated; and
responsive to receiving the indication, forwarding the incoming call to the called device, thereby breaking through the do-not-disturb status.
